(19) United States
(12) Patent Application Publication
(10) Pub. No.: US 2009/0136862 A1
(43) Pub. Date: May 28, 2009

(54) Process for producing binder resin for electrostatic charge image developing toner and process for producing toner therewith

(75) Inventors: Takashi Terabayashi, Tochigi (JP); Kazuhiro Masuko, Tochigi (JP)

Correspondence Address: YOUNG & THOMPSON, 209 Madison Street, Suite 500, ALEXANDRIA, VA, 22314, US

(73) Assignee: NIPPON CARBIDE KOGYO KABUSHIKI KAISHA, TOKYO (JP)

(21) Appl. No.: 11/921,565

(22) PCT Filed: Jun. 6, 2005
(86) PCT No.: PCT/JP2005/010345

§ 371 Date: Dec. 5, 2007

(51) Int. Cl. G03G 9/087; G03G 5/00

(52) U.S. Cl. 430/108.1; 430/137.15

(57) ABSTRACT

A process for producing a binder resin for electrostatic charge image developing toner, including the step (1) of mixing in combination with a raw material containing a low-molecular-weight resin and a high-molecular-weight resin and the step (2) of simultaneously therewith and/or thereafter removing a volatile component, characterized in that the raw material of the step (1) further contains a wax. Further, there is provided a process for producing an electrostatic charge image developing toner, characterized in that the above binder resin for toner is further loaded with the colorant.

### TECHNICAL FIELD

The present invention relates to a process for producing a binder resin for electrostatic charge image developing toner in electrophotography, electrostatic recording, electrostatic printing, or the like and more particularly to the process for producing the binder resin for electrostatic charge image developing toner comprising a step (1) of mixing a raw material for the binder resin which contains a low-molecular-weight resin, a high-molecular-weight resin, and waxes, and a step (2) of simultaneously therewith and/or thereafter removing a volatile component.

### BACKGROUND TECHNOLOGY

As a process for developing electrostatic charge images, technological developments of a dry developing method have been made rapidly in recent years. In the dry developing method, various methods of fixing images are already known. A contact-type heating fixation method using a fixing machine represented by a heating roller fixation machine, in particular, is excellent in that its heating efficiency is higher compared with a non-contact type heating fixation method using a heating plate fixation machine or the like and, in particular, in that both high-speed fixation and low-temperature fixation are made possible. In the heating roller fixation method, after a toner image obtained by being developed on an electrostatic recording unit (photosensitive drum) using toner is transferred to a transfer sheet such as paper, by letting the transfer sheet pass through a fixing roller so that the transfer sheet is heated and pressed by pressure, the toner image is fused and adhered on the sheet for being fixed. However, when fixation is performed by using conventional toner according to the heating roller fixation method, a problem arises that, due to contact between a surface of a heated roll and the toner in a fused state, the toner is made to stick to the surface of the heated roll and is transferred to the sheet and then the toner is again transferred to a succeeding transfer sheet, thus resulting in staining, that is, in the occurrence of an off-set phenomenon.

Generally, electrostatic charge image developing toner consists of a resin component, a colorant component such as pigment, magnetic powder, dye, or the like and an additive component such as a parting agent, a charge controlling agent or the like and it is thought that, in the above contact-type heating fixation method, the lower the melt viscosity of a resin component is, that is, the lower the molecular weight of the resin component is, the better the fixing efficiency is, while the higher the melt viscosity of the resin component is, that is, the higher the molecular weight of the resin component is, the harder the off-set phenomenon occurs. Therefore, in order to achieve reliable fixation at a temperature to be set for fixing and also to prevent undesired off-set phenomena, a method has been studied in which a binder resin is made to contain a mixture of a low-molecular-weight polymer and a high-molecular-weight polymer.

However, as a result of rapid progression of an information-oriented society in recent years, in a field of electrophotography or the like, a high-speed image operation and sharpness of an image are required and, therefore, it is difficult to obtain both the good fixing property and anti-offset property simply by using the mixture of the low-molecular-weight polymer and high-molecular-weigh polymer described above.

To solve this problem, various methods using a complex of low-molecular-weight polymers and high-molecular-weight polymers as a binder resin for toner have been studied (see, for example, Patent Documents 1 to 3).

According to the Patent Document 1, a high-molecular-weight polymer is produced by a suspension polymerization method using a polyfunctional polymerization initiator and a low-molecular-weight polymer is further produced in the presence of the produced high-molecular-weight polymer and then the resulting polymer is dried to obtain a solventless mixture containing high-molecular-weight polymer and low-molecular-weight polymer and the obtained mixture is used as a binder resin for toner.

Generally, the suspension polymerization method is a method suitable for producing high-molecular-weight polymers and, particularly, a polyfunctional polymerization initiator acts as a polymerization starting substance to produce a plurality of polymers and, therefore, when the polyfunctional polymerization initiator is used, it is possible to comparatively easily obtain polymers such as star-shaped high-molecular-weight polymers. However, many inconvenient problems are apt to occur at the stage of producing low-molecular-weight polymers by using the suspension polymerization method. That is, the method disclosed in the Patent Document 1 presents problems in that, since low-molecular-weight polymers are produced by adding a large amount (for example, about 10 weight parts of the initiator with respect to 100 weight parts of monomers residing at the time) of polyfunctional polymerization initiators such as benzoyl peroxide to continue a polymerization reaction at a time when a conversion rate in the polymerization induced by the polyfunctional polymerization initiator reaches a desired level according to the disclosed technology, a very large amount of decomposed products (for example, benzoic acid) of the polyfunctional polymerization initiator is contained in the obtained mixture of polymers and, as a result, odor occurs during the use of the obtained toner and, in many cases, image density is varied due to unstable charge amounts and, further under conditions of high temperature and humidity, blocking of the obtained toner is liable to occur while being stored.

Moreover, in the Patent Document 2, technology is disclosed by which a solvent contained in a solution of a low-molecular-weight polymer obtained by solution polymerization is removed and the low-molecular-weight polymer is solidified and then is dissolved in a polymeric monomer to be subjected to suspension polymerization using a polyfunctional polymerization initiator to produce a high-molecular-weight polymer to be used as a binder resin for toner. However, in the technology disclosed in the Patent Document 2, the process of removing a solvent contained in the solution of the low-molecular-weight polymer obtained by the solution polymerization, which are complicated and lead to an increase in costs, are unavoidable.

Furthermore, a method is disclosed in Patent Document 3 by which a low-molecular-weight polymer made by solution polymerization is combined with a high-molecular-weight polymer made by bulk polymerization in an organic solvent and then the solvent is removed in vacuum to obtain a resin mixture of the high-molecular-weight polymer with the low-molecular-weight polymer by using processes of, for example, polymerizing a monomer by bulk polymerization to produce a high-molecular-weight polymer and, when conversion rates in the polymerization reach a desired level, by adding an organic solvent and a polymerization initiator to carry out polymerization of low-molecular-weight polymers. However, the above method also requires the process of removing the solvent to obtain a solventless resin mixture, resulting in much time and labor and an increase in costs.

The inventors of the present invention have already filed two patent applications with the aim of solving problems associated with the binder resin disclosed in the above Patent Documents (see Patent Documents 4 and 5). The purpose of one of these two inventions is to produce a binder resin for toner being a solventless resin mixture by mixing a low-molecular-weight polymer in a solventless state or in an organic solvent form with a high-molecular-weight polymer in an aqueous emulsified/dispersed liquid state or in its sludge state by stirring and simultaneously therewith and/or thereafter by removing a volatile component and the purpose of the other is to produce toner by further mixing the invented binder resin for toner with a colorant.

In order to improve a fixing property and anti-offset property of toner, in addition to the modification of the existing binder resin, addition of waxes such as low-molecular-weight polypropylene to the toner is being studied (see Patent Document 6). According to the method disclosed in the Patent Document 6, toner is obtained by mixing a styrene polymer whose ratio of weight-average molecular weight to number-average molecular weight is 3.5 or more with the colorant including polyalkylene such as polypropylene with its weight-average molecular weight of 1,000 to 45,000 and carbon black and, if necessary, with a charge controlling agent, plasticizer, or the like, and by fully dispersing the mixture using a ball mill or the like and then by fusing and kneading the mixture using a heated roll or the like and further by pulverizing and classifying the mixture after cooling.

Additionally, in the above Patent Documents 2, 4, and 5, mixing of the binder resin obtained by the methods described in these Patent Documents with waxes such as polypropylene is disclosed. However, in the toner disclosed in the Patent Document 2, there is the problem as described above at the stage of producing the binder resin to be used and the binder resin disclosed in the Patent Document 6 presents a problem in that a fixing property and anti-offset property of the resin per se are not satisfactory.

In general, when a styrene polymer being widely used as a binder resin is mixed with waxes, due to poor compatibility between the styrene polymer and waxes, phase separation is liable to occur at a time of kneading the mixture. If mechanical force caused by friction among toner particles in a copying machine or a printer and/or between the toner particle and a carrier to carry the toner and to contribute to charging of the toner is applied to the interface where the phase separation has occurred, the toner is easily destroyed and too-finely pulverized. The destroyed and too-finely pulverized toner substances are fused and stuck to the surface of the carrier, resulting in staining of the carrier, that is, the substances cause a toner spent phenomenon to become liable to occur and are also fused and stuck on a developing sleeve serving as a toner carrying member, the substances cause a filming phenomenon to occur in many cases. The occurrence of the toner spent leads to a decrease in charging sites of the carrier, which causes changes in friction charged amounts of a two-component developer, resulting in inconvenience of changes in image density and of the occurrence of image fogging or the like. The occurrence of the filming phenomenon leads to a secular decrease in toner charging capability on the developing sleeve, causing greasing on an image and image density non-uniformity. If the usage amount of waxes is increased, with the aim of further improving a fixing property and anti-offset property of the toner, the toner spent and filming are more liable to occur.

In the toner disclosed in the above Patent Documents 2 and 6, the occurrence of the toner spent and filming is unavoidable. It has turned out that, even the toner invented by the inventors of the present invention disclosed in the Patent Documents 4 and 5 is not fully satisfactory in terms of the prevention of toner spent and/or filming caused by destroyed and too-finely pulverized toner substances.

In recent years, a pigment with a charging property such as ferrite and magnetite, instead of carbon black, is often added to toner as a colorant. In that case, generally, a carrier is not used and, as a result, the problem of the occurrence of the toner spent and/or filming does not occur. However, it is necessary that the usage amount of the waxes to be added to the toner is twice as large as that of the waxes required when the carbon black is used, which causes uniform mixing of waxes, binder resins, and pigment to more difficult.

Patent Document 1: Japanese Patent Application Laid-open No. H2-48675 (Claim, 12^{th} line in right upper column to 4^{th} line in right lower column at page 4).

Patent Document 2: Japanese Patent Application Laid-open No. H2-168264 (2^{nd} to 8^{th} line in right upper column at page 4; 12^{th} line in right upper column to 5^{th} line in left lower column at page 5; 1^{st} line in right lower column at page 5 to 5^{th} line in right upper column at page 6).

Patent Document 3: U.S. Pat. No. 5,084,368 (49^{th} line in 4^{th} column to 32^{nd} line in 5^{th} column; 12 to 57^{th} line in 6^{th} column; 25^{th} in 11^{th} column to 18^{th} line in 13^{th} column; Claim in 19^{th} to 20^{th} column).

Patent Document 4: Japanese Patent Application Laid-open No. H11-72954 (all lines and pages).

Patent Document 5: Japanese Patent Application Laid-open No. H11-84725 (all lines and pages).

Patent Document 6: Japanese Patent Application Laid-open No. S 55-153944 (Claim, 12^{th} to 16^{th} line in right upper column at page 2; 15^{th} line in left lower column at page 4 to 16^{th} line in right lower column at page 4; 15^{th} to 20^{th} line in lower column at page 6; 8^{th} to 16^{th} line in left upper column at page 7).

### DISCLOSURE OF THE INVENTION

### Problems to be Solved by the Invention

The inventors of the present invention have earnestly studied, continuously following the previous filing of the patent application, to develop a method for effectively and easily producing a binder resin for toner which enables production of an electrostatic charge image developing toner being excellent in anti-offset property, fixing property, toner-spent preventing property, filming preventing property, anti-blocking property (non aggregating property), and development property at a time of image formation and the like and being able to eliminate the occurrence of odor and an electrostatic charge image developing toner. As a result, the inventors found that a resin mixture obtained by mixing a solventless low-molecular-weight resin such as a styrene low-molecular-weight polymer and a high-molecular resin aqueous dispersed liquid such as a styrene polymer in the presence of polypropylene wax having its softening point being about 150° C. and then by removing a volatile component was so excellent as to solve all problems associated with properties of the binder resin for an electrostatic charge image developing toner and have continuously studied to complete the present invention.

### Means for Solving Problems

Therefore, the present invention provides a process for producing a binder resin for electrostatic charge image developing toner, comprising a step (1) of mixing a raw material for the binder resin which contains a low-molecular-weight resin and a high-molecular-weight resin, and a step (2) of simultaneously therewith and/or thereafter removing a volatile component, wherein the raw material used in the step (1) further contains waxes.

Further, the present invention provides a process for producing electrostatic charge image developing toner comprising a process of further mixing a colorant with the binder resin for the toner.

### BRIEF DESCRIPTION OF DRAWINGS

FIG. 1 is a diagrammatic plan view schematically showing configurations of a sealed-type biaxial continuous kneading machine that can be used suitably for the present invention.

FIG. 2 is a diagrammatic side view schematically showing configurations of the sealed-type biaxial continuous kneading machine that can be used suitably for the present invention.

FIG. 3 is a diagrammatic cross-sectional view schematically showing configurations of the sealed-type biaxial continuous kneading machine of FIG. 1 taken along the line A-A′ that can be used suitably for the present invention.

### BEST MODE FOR CARRYING OUT THE INVENTION

Hereinafter, the present invention is further described in detail.

A process for producing a binder resin for electrostatic charge image developing toner of the present invention is characterized in comprising the step (1) of mixing a raw material for the binder resin which contains a low-molecular-weight resin, a high-molecular-weight resin, and waxes [hereinafter this step being called a mixing step (1) or simply a step (1)] and the step (2) of simultaneously therewith and/or thereafter removing a volatile component [hereinafter this step being called a volatile component removing step (2) or simply a step (2)].

The producing method of the above low-molecular-weight resin is not limited to the method described above and the low-molecular-weight resin can be obtained by the method in which a solventless resin is made by condensation polymerization, addition polymerization, bulk polymerization of a vinyl monomer, or the like, by the method in which a resin solution or resin aqueous dispersed liquid is obtained by solution polymerization, emulsion polymerization, or the like, or by other similar methods. Out of these methods, the method using the bulk polymerization of a vinyl monomer is preferable from viewpoints that the use of an organic solvent, emulsifier, or the like is not required and manufacturing operations are comparatively easy and easy addition in a fused state in the above mixing step (1) is allowed and volatile components to be removed in the above volatile component removing step (2) are very small.

The above “solventless resin” is defined as a resin existing in a flake-like, powder-like, particle-like, or block-like state, or in a fused state, which contains 10 or less weight % of water and organic solvents and preferably 5 or less weight % and, more preferably, contains substantially neither water nor organic solvents.

Moreover, the method of adding the low-molecular-weight resin in the above mixing step (1) includes a method by which the solventless resin is added in a flake-like, powder-like, particle-like, or block-like state, a method by which the solventless resin is added in a fused state, a method by which the resin is added in a resin solution form or in a resin dispersing liquid form, or the like. When the low-molecular-weight resin is made by bulk polymerization, the obtained solventless resin can be used directly for the addition in the above mixing step (1). In the case of solution polymerization, the resin solution to be obtained can be added, as it is, as the solventless resin, or the resin solution from which an organic solvent is removed, as appropriate, by a known method can be added as the solventless resin. Moreover, in the case of emulsion polymerization, a resin aqueous dispersed liquid to be obtained, as it is, can be directly added, or the resin aqueous dispersed liquid obtained by preliminarily mixing with an aqueous dispersed liquid of a high-molecular-weight resin to be described later can be added, or the resin aqueous dispersed liquid obtained by preliminarily blending a mixture of the resin aqueous dispersed liquid of the high-molecular-weight resin with further an aqueous dispersed liquid of waxes to be described later can be added, or the low-molecular-weight resin aqueous dispersed liquid can be singly added, or a preliminary mixture of an aqueous dispersed liquid of two kinds or more of the low-molecular-weight resins can be added as a sludge as described later.

Out of these methods of adding the low-molecular-weight resin, the preferable method is to add the solventless resin in a fused state owing to reasons that continuous operations are made possible and homogeneity of the binder resin to be obtained is high.

The bulk polymerization can be carried out by mixing a vinyl monomer and a polymerization initiator dissolved in the vinyl monomer and by heating a material mixture substantially not containing a solvent, dispersing agent, emulsifier, or the like up to polymerization temperature. As a method of performing the polymerization, any one of the batch polymerization methods in which all materials are made to react in one polymerization tank, the continuous polymerization method in which processes of adding materials, of polymerization method, and of taking out a polymer are continuously performed, and the semi-continuous polymerization method in which the above methods are combined together can be selected. However, the effective and preferable method is to perform the bulk polymerization continuously and to add the obtained low-molecular-weight resin directly, as it is, in a fused state in the step of mixing with a high-molecular-weight resin.

The molecular weight of the low-molecular-weight resin to be used in the present invention is measured by methods described below and the molecular weight preferably has a molecular-weight characteristic within a specified range.

The measurement of molecular-weight characteristics of the sample is made by using a gel permeation chromatography (GPC) apparatus “HLC-8220” (product name; manufactured by TOSOH Corporation) equipped with two columns “TSK gel GMH x1” (product name; manufactured by TOSOH Corp.) A sample of each resin was dissolved in tetrahydrofuran (THF) so that its concentration became 0.2 weight %, and, after about 150 μL of the solution was poured into the apparatus at 20° C., the measurement of molecular-weight characteristics was made by letting the THF solution flow at a flow rate of 1 mL/minute. Moreover, when the measurement of molecular-weight characteristics of the sample is made, measuring conditions were set so that the molecular weight of the sample was fallen within a range in which the logarithm of molecular weight of a calibration curve created based on several kinds of mono-dispersed polystyrene standard samples was linear to the counted numbers.

In the obtained GPC measurement chart, a molecular weight with a maximum value (molecular-weight peak) is represented as “Mp” and the number-average molecular weight and weight-average molecular weight calculated by computer operations are represented as “Mn” and “Mw” respectively and a ratio of the weight-average molecular weight to the number-average molecular weight (Mw/Mn) is used as an index of molecular-weight distribution.

The molecular-weight peak value (MP_{L}) of the low-molecular-weight resin is preferably within a range between 1,500 and 30,000 and more preferably within a range between 2,000 and 20,000. It is preferable that the value “MP_{L}” is above the lower limit value described above and, if so, the toner to be obtained has a good fixing property and the inconvenience that a life of the toner as a developer is shortened due to condensation in a developing machine is hard to occur and, further, the toner to be obtained is excellent in storage stability and the inconvenience that the toner is solidified during a storage period at high temperature is hard to occur. Moreover, it is preferable that the “MP_{L}” is below the upper limit value described above and, if so, the inconvenience of a toner spent state and/or filming phenomenon is hard to occur in the toner that can be obtained and, additionally, the toner to be obtained is excellent in the fixing property in a low temperature range and, therefore, the inconvenience that a cold off-set temperature becomes useless due to an increase in lower limit temperature for fixation is hard to occur.

In the present invention, the low-molecular-weight resin denotes the resin having its weight-average molecular weight (Mw_{L}) of 1,000 to 50,000 and the weight-average molecular weight (Mw_{L}) of the present invention is preferably within a range between 1,000 and 30,000 and more preferably within a range between 1,000 and 20,000. It is preferable that the value “Mw_{L}” is above the lower limit described above and, if so, the toner to be obtained has a good fixing property and the inconvenience that a life of the toner as a developer is shortened due to condensation in a developing machine is hard to occur and, further, the toner to be obtained is excellent in storage stability and the inconvenience that the toner is solidified during storage periods at high temperatures is hard to occur. It is preferable that the value “Mw_{L}” is below the upper limit described above and, if so, the toner spent state and/or toner too-finely pulverized state are hard to occur in the toner that can be obtained and the toner is excellent in a fixing property in a low temperature range and, therefore, the inconvenience that the cold off-set temperature becomes useless due to an increase in lower limit temperature for fixation.

The ratio (Mw_{L}/Mn_{L}) of the weight-average molecular weight (Mw_{L}) of the above-described low-molecular-weight resin to the number-average molecular weight (Mn_{L}) of the above-described low-molecular-weight resin is preferably less than 4. It is preferable that the ratio (Mw_{L}/Mn_{L}) is less than the above upper limit and, if so, fixation failure in the toner is hard to occur.

In the present invention, any low-molecular-weight resin may be used without limitation so long as the resin is suitable as a binder resin for toner. Such a resin being usable includes, for example, an acrylic polymer, styrene polymer, epoxy resin, polyester resin, styrene-butadiene copolymer. The styrene polymer is preferably used since desired properties of toner can be more easily obtained by using the copolymer.

In the present invention, the above styrene polymer denotes a (co)polymer in which 50 weight % of a styrene monomer is (co)polymerized and preferably 60 weigh % of the styrene monomer. The example of the styrene monomer includes styrene, α-methylstyrene, o-methylstyrene, m-methylstyrene, p-methylstyrene, p-ethylstyrene, 2,4,-dimethylstyrene, p-n-butylstyrene, p-t-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorstyrene, 3,4-dichorstyrene, or the like. Out of these styrene monomers, the styrene is most preferably used.

As other monomers that can copolymerize with the above styrene monomer, any monomer may be used without limitation so long as it can copolymerize with the styrene monomer. An acrylic monomer is preferably used. The example of such an acrylic monomer includes acrylate such as methyl acrylate, ethyl acrylate, n-butyl acrylate, isobutyl acrylate, 2-ethylhexyl acrylate, and methacrylate such as methyl methacrylate, ethyl methacrylate, n-butyl methacrylate, isobutyl methacrylate, lauryl methacrylate, stearyl methacrylate. In particular, n-butyl acrylate, 2-ethylhexyl acrylate, n-butyl methacrylate can be suitably used. The glass transition temperature (Tg_{L}) of the styrene copolymer to be suitably used as the low-molecular-weight resin of the present invention is preferably within a range between 40° C. and 80° C. and more preferably within a range between 50° C. and 70° C.

A method of producing the low-molecular-weight resin to be suitably used in the present invention is the bulk polymerization described above, the polymerization temperature is preferably 130° C. to 250° C., more preferably 170° C. to 250° C. and most preferably 190° C. to 230° C. It is preferable that the polymerization reacting temperature is above the lower limit temperature described above and, if so, a good reaction rate is provided and the inconvenience that molecular-weight peak value (Mp_{L}) of the polymer to be obtained becomes too high does not occur. Also, it is preferable that the polymerization reacting temperature is below the upper limit temperature described above and, if so, the inconvenience that an oligomer with its molecular weight of 500 or less is increased due to the occurrence of a depolymerization reaction is hard to occur and, therefore, a storage property, toner spent phenomenon, toner too-fine pulverization are hard to occur in the toner produced by mixing the polymer that can be obtained here.

As the polymerization initiator to be used in the bulk polymerization, any known oil-soluble polymerization initiator can be used. The polymerization initiator that can be suitably used in the present invention includes, for example, benzoyl peroxide, t-butyl hydroperoxide, di-t-butyl hydroperoxide, cumene hydroperoxide, t-hexyl hydroperoxide, p-menthan hydroperoxide, azobisisobutylnitrile, or the like. In the present invention, since it is most preferable to use a temperature as a reaction temperature as high as 170° C. or more, out of these initiators, a high temperature decomposing initiator such as t-butyl hydroperoxide or di-t-butyl hydroperoxide is most preferably used. The usage amount of the polymerization initiator is preferably 0.01 to 5 weight parts with respect to 100 weight parts of the total monomers and more preferably 0.03 to 3 weight parts and most preferably 0.05 to 1 weight parts.

It is desirous that the reaction temperature and reaction retentive time are set so that the conversion rate of the styrene low-molecular-weight polymer obtained as above is 90% or more, preferably 95% or more, even more preferably 97% or more and, if necessary, the residual monomer can be collected by using a thin-film evaporation apparatus.

The low-molecular-weight polymer made by the bulk polymerization is preferably used since it can provide a property of holding charging characteristics of the toner to be obtained in particular and it can reduce odor of the toner.

As the low-molecular-weight resin to be used in the present invention, a low-molecular-weight resin made by conventional solution polymerization may be employed. The low-molecular-weight resin made by the solution polymerization may be added, as it is, as the resin solution as described above and also the resin may be used as a solventless resin obtained by removing an organic solvent from the resin solution, as appropriate, by a known method as described above.

The solution polymerization to be used for producing the above low-molecular-weight resin can be carried out in a manner in which the monomer used in the bulk polymerization, polymerization initiator, solvent in which the monomer and polymerization initiator are dissolved are mixed and their mixture is then heated.

The above solvent is not limited to the solvent described above and any solvent may be used. The example of the solvent includes aliphatic hydrocarbons such as pentane, hexane, heptane, octane, alicyclic hydrocarbons such as cyclohexane, methylcyclohexane, aromatic hydrocarbons such as benzene, toluene, xylene, ethylbenzene, diethylbenzene, and halogenated hydrocarbons such as 1-chlorbutane, amyl chloride, ethylene dibromide, methylene chloride, ethylene dichloride, propylene dichloride, dichlorpentane, chloroform, 1,1,2-trichlorethane, 1,2,3-trichlorpropane, carbon tetrachloride, 1,1,2,2-tetrachlorethane, trichlorethylene, perchlorethylene, epichlorhydrin, monochlorobenzene, dichlorbenzene, fluorinated hydrocarbon.

For example, alcohols such as methyl alcohol, ethyl alcohol, allyl alcohol, propyl alcohol, butyl alcohol, amyl alcohol, hexyl alcohol, octyl alcohol, for example, amines such as diethylamine, triethylamine, butylamine, diamylamine, propylenediamine, aniline, dimethylaniline, cyclohexylamine, monoethanolamine, diethanolamine, triethanolamine, pyridine, quinoline, and ketones such as acetone, methylethyl ketone, methylpropyl ketone, methylisobutyl ketone, methylamyl ketone, methylhexyl ketone, diisobutyl ketone, cyclohexanone, methylhexanone.

For example, ethers such as ethyl ether, isopropyl ether, n-butyl ether, n-hexyl ether, dioxane, tetrahydrofuran, methyl cellosolve, ethyl cellosolve, buthyl cellosolve, methyl carbitol, ethyl carbitol, butyl carbitol, acetal, or the like, for example, esters such as diethyl carbonate, methyl formate, ethyl formate, butyl formate, methyl acetate, ethyl acetate, propyl acetate, butyl acetate, amyl acetate, furfuryl acetate, ethyl propionate, butyl propionate, amyl propionate, ethyl butyrate, butyl butyrate, amyl butyrate, diethyl oxalate, dibutyl oxalate, methyl lactate, ethyl lactate, butyl lactate, or the like, for example, petroleum hydrocarbons such as gasoline, petroleum ether, petroleum benzene, ligroin, mineral spirit, kerosine, gas oil, heavy oil, or the like, for example, nitrated hydrocarbons such as nitromethane, nitroethane, nitropropane, nitrobenzene, or the like, for example, nitriles such as acetonitrile, benzonitrile, or the like, and other solvents such as carbon disulfide and these solvents may be used singly or by mixing a plurality of solvents.

Out of these solvents, aliphatic hydrocarbons, alicyclic hydrocarbons, aromatic hydrocarbons, ketones, ethers, esters are preferably used from a viewpoint of good compatibility with the low-molecular-weight resin to be obtained. Moreover, in either case of directly adding the obtained resin solution in the mixing step (1) or adding the solventless resin obtained by volatizing and dispersing an organic solvent from the resin solution, from a viewpoint of a good evaporation removal property, the solvent with a boiling point of 50° C. to 150° C. is preferably selected.

The polymerization temperature for the above solution polymerization is generally within a range between 40° C. and 250° C. and preferably between 60° C. and 230° C. and more preferably between 70° C. and 220° C.

In the case of directly adding the obtained resin solution in the mixing step (1), the resin solution generally contains over 10 weight % of the solvent, for example, 20 to 80 weight %, and preferably 30 to 70 weight %.

When the low-molecular-weight resin to be used in the present invention is made by emulsion polymerization, the monomer used in the bulk polymerization described above, the emulsifier and polymerization initiator both being the same as employed for producing high-molecular-weight polymers by the emulsion polymerization described later are used and, if necessary, the low-molecular-weight resin can be produced at polymerization temperature applied to the production of high-molecular-weight polymers by emulsion polymerization described later by using a known chain transfer agent.

According to the process of producing the binder resin for electrostatic charge image developing toner of the present invention, in the above mixing step (1), the high-molecular-weight resin together with the low-molecular-weight resin described above is added to be mixed. The method for adding the high-molecular-weight resin is not limited and includes the method in which the high-molecular-weight resin is added in an aqueous dispersed liquid form, the method in which the high-molecular-weight resin is added in an aqueous sludge form, wherein the aqueous sludge is obtained by lowering the dispersion stability of the aqueous dispersed liquid, as appropriate, by a known way, however, the high-molecular-weight resin obtained by emulsion polymerization can be used as it is and it is preferable that the method in which the high-molecular-weight resin is added in the aqueous dispersed liquid form for the reason that the aqueous dispersed liquid obtained by emulsion polymerization can be used as it is and the addition in the aqueous dispersed liquid can provide the resin mixture with high homogeneity. Other methods for the addition of the high-molecular-weight resin includes the method in which aqueous dispersed liquid of the high-molecular-weight resin is mixed in advance with aqueous dispersed liquid of the low-molecular-weight resin described above and/or with aqueous dispersed liquid of waxes described later before being added in the mixing step and the method in which the mixture of the aqueous dispersed liquid is changed into aqueous sludge before being added in the mixing step.

The aqueous dispersed liquid to be used in the present invention is not limited to the liquid described above and any aqueous dispersed liquid can be used so long as a high-molecular-weight resin is dispersed in an emulsified state. For example, resin aqueous dispersed liquid obtained by forcedly emulsifying and dispersing the resin in water, as appropriate, by using a known emulsifier, resin aqueous dispersed liquid obtained by emulsion polymerization of the resin, or the like can be used. The resin aqueous dispersed liquid obtained by emulsion polymerization is preferably selected from the viewpoint that a resin having a high molecular weight can be obtained and the obtained resin is stable when being stored and being mixed with a low-molecular-weight resin. Moreover, resin particles being self-stabilized owing to a polarity of a resin per se and being obtained without the use of an emulsifier may be employed.

The molecular-weight characteristics of the high-molecular-weight resin to be used in the present invention are measured by the method described in the above “Measurement of molecular-weight characteristics”. The molecular-weight peak value (Mp_{H}) in the measurement chart obtained by the gel permeation chromatography (GPC) apparatus is preferably within a range between 300,000 and 3,000,000, more preferably within a range between 500,000 and 2,000,000, and even more preferably within a range between 600,000 and 1,000,000. It is preferable that the value (Mp_{H}) is above the lower limit value and, if so, the toner that can be obtained provides an excellent fixing property and the inconvenience that a fixable temperature range is narrowed due to the occurrence of a hot off-set phenomenon of the toner is hard to occur.

The above high-molecular-weight resin of the present invention denotes the resin whose weight-average molecular weight (Mw_{H}) is larger than the weight-average molecular weight (Mw_{L}) of the low-molecular-weight resin and whose weight-average molecular weight (Mw_{H}) is 100,000 or more and it is preferable that the weight-average molecular weight (Mw_{H}) of the high-molecular-weight resin is 200,000 or more. It is preferable that the value (Mp_{H}) is above the lower limit value and, if so, the toner that can be obtained provides an excellent fixing property and the inconvenience that a fixable temperature range is narrowed due to the occurrence of hot off-set of the toner is hard to occur. Moreover, when necessary, the high-molecular-weight resin may be used in combination with an intermediate molecular-weight resin having an intermediate molecular weight between the low-molecular-weight resin and the high-molecular-weight resin.

In the present invention, the high-molecular-weight resin and the low-molecular-weight resin may be of the same kind. For example, a styrene polymer can be used both as the high-molecular-weight resin and as the low-molecular-weight resin.

When aqueous dispersed liquid is used as the high-molecular-weight resin, an average particle diameter of the dispersed particles is preferably within a range between 30 nm and 1000 nm. It is preferable that the average resin particle diameter is below the upper limit value and, if so, the high-molecular-weigh resin is excellent in compatibility with the low-molecular-weight resin and in dispersion property and the inconvenience that the fixing property of the toner to be obtained is insufficient and a fixable temperature range is narrowed due to the occurrence of hot off-set of the toner is hard to occur. Moreover, it is preferable that the particle diameter of the above resin emulsifying and dispersing liquid is above the lower limit and, if so, a usage amount of the emulsifier to be used at the time of emulsification and polymerization can be made comparatively small and, therefore, the inconvenience that an electric resistance of the toner to be obtained is lowered is hard to occur.

The average particle diameter of the dispersed resin particles of the high-molecular-weight resin is a value obtained by measurement using a laser diffraction-type particle size distribution measuring apparatus and, more particularly, is a weight-average particle diameter measured by using “Mastersizer 2000” (product name; manufactured by SYSMETICS LTD.).

In particular, compatibility and dispersion properties of the low-molecular-weight resin in the solventless form with the high-molecular-weight resin in the aqueous dispersed liquid form or in an aqueous sludge form exert an influence on fixation and durability of the toner to be obtained. If the above compatibility and dispersion properties are poor, at a time of fixation, hot off-set and cold off-set phenomena are liable to occur at the same time and, further, a toner-spent state and too-fine pulverization of the toner also are apt to occur and a life of the toner as a developer is made shorter.

To obtain aqueous dispersed liquid of the high-molecular-weight resin to be used in the present invention by emulsion polymerization, a monomer, aqueous solvent, emulsifier and water serving as a polymerization medium are mixed and their mixture is then heated up to polymerization temperature.

The above polymerization may be carried out by adding all amounts of the materials in the polymerization tank and by raising a temperature of the materials up to the polymerization temperature or by pouring at least part of the water into the polymerization tank whose temperature has been set to be the polymerization temperature and then adding the residual water, part or all of the monomer, aqueous catalyst, and emulsifier to the polymerization tank intermittently or continuously. Also, the monomer may be added singly to the polymerization tank or may be emulsified in advance in a solution of the emulsifier in water to make emulsified liquid of the monomer for the addition to the polymerization tank.

The polymerization temperature is not limited to any specified temperature and any temperature may be applied so long as a catalyst is decomposed at the temperature to be applied and, in general, the polymerization temperature is within a range between 30° C. and 150° C., preferably within a range between 40° C. and 100° C.

As the above monomer, in addition to the monomer to be used as a polymer component having the above low molecular weight and to be employed for polymerization of the resin in the resin solution, a polyvinyl monomer with two or more polymeric double bonds may be used in combination. The example of the polyvinyl monomer includes an aromatic divinyl compound such as divinylbenzene and divinylnaphthalene, a polyol poly(meta) acrylate compound such as ethylene glycol dimethacrylate, tetraethylene glycol dimethacrylate, 1,3-butanediol dimethacrylate, 1,6-hexanediol diacrylate, neopentyl glycol di(meta)acrylate, trimethylol propane tri(meta)acrylate, pentaerythritol tri(meta)acrylate, an unsaturated alcohol poly(meta)acrylate such as allyl metacrylate, and other divinyl compounds such as N,N-divinyl aniline, divinyl ether, divinyl sulfide, and triallyl cyanurate. Out of these, divinylbenzene, ethylene glycol dimethacrylate, 1,6-hexanediol diacrylate, or the like are suitably used.

The rate of the copolymerization of these crosslink polyvinyl monomers is generally within a range of 0 to 2 weight % with respect to 100 weight % of the monomers making up the high-molecular-weight resin, preferably within a range of 0.01 to 1 weight %, most preferably within a range of 0.02 to 0.8 weight %.

As the polymerization initiator that can be used in the above emulsion polymerization, any conventional aqueous initiator may be employed. The example includes a free radical polymerization initiator such as hydrogen peroxide, alkyl hydroperoxide such as t-butyl hydroperoxide and t-amyl hydroperoxide, dialkyl peroxide, persulfate such as ammonium persulfate, potassium persulfate, sodium peroxide, peroxy ester, peroxy carbonate, ketone peroxide such as methyl ethyl ketone peroxide and an azo initiator such as 2,2-azobis (2-amidinopropane) and 2,2-azobis (4-cyanovaleric acid). The usage amount of the polymerization initiator is preferably within a range from 0.03 to 1 weight parts with respect to 100 weight parts of the total monomers and more preferably within a range from 0.05 to 0.8 weight parts and most preferably within a range from 0.1 to 0.05 weight parts.

An aqueous redox polymerization initiator obtained by combining the above aqueous polymerization initiator with a aqueous reducing agent can be also used. The polymerization initiator described above can be employed as the polymerization initiator to be used for the aqueous redox initiator. The example of the reducing agent to be used includes, sodium sulfite, sodium bisulfite, sodium metabissulfite, sodium pyrosulfite, hypophosphours acid, ascorbic acid, tartaric acid, citric acid, grape sugar, sodium formaldehyde sulfoxylate, or the like. The usage amount of peroxide of the redox catalyst is within 0.03 to 1 weight parts with respect to 100 weight parts of the total monomers. In addition to the above redox polymerization initiator, a very small amount of a transition metal such as ferrous sulfate, Mohr's salt of copper sulfate, or the like can be used in combination.

As the emulsifier that can be suitably used in the emulsion polymerization of the high-molecular-weight resin aqueous dispersed liquid of the present invention, any one of an anionic emulsifier, nonionic emulsifier, cationic emulsifier, amphoric emulsifier, and reactive emulsifier may be used. As these emulsifiers, known kinds of emulsifiers can be used by known usage methods. These emulsifiers may be used singly or in combination therewith.

The pH of the obtained high-molecular-weight resin dispersing liquid can be adjusted by adding ammonia water, aqueous solution of amine or of alkali hydroxide, or the like. The concentration of a solid content in the aqueous dispersed liquid is generally within a range between 10 and 70 weight %, preferably within a range between 20 and 60 weight %, and more preferably between 30 and 50 weight %, and its viscosity is ordinarily below 10,000 mPa·s (by BH-type rotational viscometer, under conditions of 25° C. and 20 rmp) and its pH is preferably within a range from 2 to 10.

After emulsion polymerization, the most monomers are generally changed into polymers and residual amounts of the monomers are very small. However, if the concentration of the residual monomers is not sufficiently low, which may occur depending on applications, the amount of the residual monomers may be decreased by adding, after the polymerization, one or more kinds of the initiator or reducing agent or by jetting vapor or air.

The high-molecular-weight resin that can be suitably used in the present invention is produced by aqueous emulsion polymerization and, in that case, an aqueous organic solvent such as alcohol or the like is allowed to be contained as an aqueous medium.

The high-molecular-weight resin of the present invention is used, as described above, in the form of aqueous sludge of the high-molecular-weight resin, that is, in the form of aqueous dispersed liquid of resin particles obtained by decreasing dispersion stability of the aqueous dispersed liquid of the high-molecular-weight resin described above. The aqueous sludge may contain substances obtained by aggregation of resin particles dispersed in the high-molecular-weight resin aqueous dispersed liquid. The resin particles contained in the sludge, since the dispersion stability of particles has been impaired, are dispersed by mechanical stirring, however, the resin particles precipitate readily by being allowed to stand or by being diluted with water.

The method to decrease the dispersion stability of the dispersing resin particles of the above high-molecular-weight resin is not limited to any specified one and any of methods can be used which contains, for example, the method in which an salting-out operation is performed by adding an inorganic metal salt to the resin aqueous dispersed liquid, the method in which the dispersion stability of resin particles is impaired by adjusting the pH of the resin aqueous dispersed liquid, the method in which the dispersion stability is made unstable by adding organic solvents, the method in which an aqueous solution of an emulsifier having a charge being reverse to the charge of the resin dispersing particles is added, the method in which aggregation is made to occur by strong mechanical stirring of the resin aqueous dispersed liquid, and the method in which aggregation is made to occur by freezing the resin aqueous dispersed liquid and then unfreezing the frozen liquid. From a view point of easy operations, the method in which an salting-out operation is performed by adding an inorganic metal salt to the resin aqueous dispersed liquid and the method in which the dispersion stability of resin particles is impaired by adjusting the pH of the resin aqueous dispersed liquid are preferably used.

To perform the salting-out operation by adding a metal salt to the high-molecular-weight resin aqueous dispersed liquid, an aqueous solution of the inorganic salt is added while the dispersing liquid is being stirred. The inorganic metal salt that can be used in the present invention is not limited to any specified one and any salt may be used so long as it is an aqueous metal salt. The example of the inorganic metal salt includes halognide halide, sulfate, nitrate, phosphate, acetate, carbonate of various kinds of metal. The metal making up the metal salt includes sodium, potassium, magnesium, calcium, iron, zinc, barium, aluminum, titanium aluminum or the like.

When the dispersion stability of the resin particles is decreased by adjusting the pH of the resin aqueous dispersed liquid, for example, if the dispersing liquid is stabilized by the anionic emulsifier, the decrease can be achieved by lowering the pH of the resin aqueous dispersed liquid and, if the dispersing liquid is stabilized by the cationic emulsifier, the decrease can be achieved by raising the pH. In the former case, the pH of the resin aqueous dispersed liquid is from 1 to 6 and more preferably from 1 to 3. The pH can be lowered by adding hydrochloric acid, sulfuric acid, phosphoric acid, acetic acid, carbonic acid, or the like or their aqueous solutions while the resin aqueous dispersed liquid is being stirred. In the latter case, the pH of the resin aqueous dispersed liquid is from 8 to 14 and more preferably from 12 to 14. The pH can be raised by adding ammonia, various amines, or the like or their aqueous solutions.

When the dispersion stability of the resin particles is decreased by adding the organic solvents, the decrease can be achieved by adding an organic solvent which is dissolved in water and hardly dissolves the resin into the resin aqueous dispersed liquid. The example of the organic solvent includes alcohols such as methanol, ethanol, propanol, and butanol, ketons such as acetone, methyl ethyl ketone, and cyclic ethers such as dioxane, tetrahydrofuran, or the like.

When the aqueous sludge is produced by the method in which an aqueous solution of an emulsifier having a charge being reverse to that of the resin dispersing particles is added, an anionic activating agent such as carboxylic acid, sulfonic acid or phosphoric acid activating agent may be added, as the emulsifier, to positively-charged resin dispersing particles and a cationic emulsifier such as a tertiary amine or quaternary amine emulsifier may be added to negatively-charged resin dispersing particles. Moreover, the sludge can be produced by adding a polymer flocculent such as polyamine, polyacrylamide, polyacryl flocculent, a water-soluble hydrophilic colloid such as alginic acid salt or cellulose colloid.

The sludge produced as above can be used after filtering and washing resin particles contained in the produced sludge on a temporary basis with water, and then removing, by washing, the excessive emulsifier, polymerization initiator, or the like contained in the sludge and again dispersing the filtered particles in water.

The mixing rate of the low-molecular-weight resin and high-molecular-weight resin to their mixture cannot be unconditionally determined because it varies depending on a composition or molecular weight of each of the resins. Preferably the mixture of the low-molecular-weight resin and high-molecular-weight resin contains 50 to 80 weight % of the low-molecular-weight resin with respect to 100 weight % of the total mixture and more preferably 55 to 75 weight %, while the mixture of the low-molecular-weight resin and high-molecular-weight resin preferably contains 50 to 20 weight % of the high-molecular-weight resin with respect to 100 weight % of the total mixture and more preferably 45 to 25 weight %. It is preferable that the mixing rate of the low-molecular-weight resin to the mixture is above the lower limit (that is, the mixing rate of the high-molecular-weight resin is below the upper limit) and, if so, the toner that can be obtained provides a good anti-offset property and an excellent fixing property in a low temperature range and the inconvenience that fixing lower-limit temperature is raised does not occur. Moreover, it is preferable that the mixing rate of the low-molecular-weight resin is below the above upper limit (that is, the mixing rate of the high-molecular-weight resin is above the above lower limit) and, if so, the toner that can be obtained provides a good fixing property and the inconvenience that a fixable temperature range is narrowed due to the occurrence of a hot off-set phenomenon of the toner is hard to occur.

The process of producing the binder resin for electrostatic charge image developing toner of the present invention is characterized in that the low-molecular-weight resin and high-molecular-weight resin and waxes are all together added and mixed in the mixing step (1). Conventionally, the waxes are fused and mixed, as a parting agent to prevent the off-set phenomenon of toner occurring, which transfer and adhesion of the toner onto the surface of a heated roll, together with the binder resin for the toner, colorant, charge controlling agent, magnetic substance at the stage of production of the toner. However, the inventors of the present invention have found that, by adding and mixing all the low-molecular-weight resin, high-molecular-weight resin, and waxes at the stage of production of the binder resin for toner, long-time continuous printing can be done without the occurrence of the toner spent and filming phenomena described above and a cold off-set phenomenon that is apt to occur due to a decrease in temperature of the heated roll during the long-time continuous printing can be reduced remarkably.

The waxes that can be employed in the producing method are not limited to any specified waxes and can be selected, as appropriate, from aliphatic hydrocarbon wax, fatty acid ester wax, fatty acid wax, aliphatic alcohol wax, carboxylic acid wax, and their derivatives and mixtures. According to the present invention, from a viewpoint that waxes are not separated from toner at a time of high temperature storage and are excellent in anti-high temperature off-set property while being used, the wax whose softening point is within a range between 55° C. and 160° C. is preferably used and more preferably within a range between 60° C. and 150° C., and most preferably between 60° C. and 100° C.

Moreover, the softening point of each of the waxes described in this specification is a value measured according to the Ring-and-Ball method designated as JIS K 2207.

The example of the above aliphatic hydrocarbon wax includes a low-molecular-weight polyolefin wax, Fischer-Tropsch wax, paraffin wax, microcrystalline wax, petrolatum, ozokerite wax, selecin wax, or the like.

The low-molecular-weight polyolefin wax is a polymer with its molecular weight of 500 to 10000 derived by carrying out radical polymerization under high pressure or ion polymerization by using a Ziegler catalyst, of an olefin monomer containing α-olefin having 2 to 10 carbon atoms (preferably 2 to 6 carbon atoms) such as ethylene, propylene, 1-butene, 1-pentene, 2-methyl-1-butene, 3-methyl-1-butene, 1-hexene, 4-methyl-1-pentene, 3-methyl-1-pentene, 2-methyl-pentene, 1-heptene, 4-methyl-1-hexen, 1-octene, 5-methyl-1-heptene, 1-decene, and ethylene, propylene, 1-butene, 4-methyl-1-pentene (preferably, ethylene, propylene, 1-butene, 4-methyl-1-pentene) as a main component (50 or more mol %, preferably 80 or more mol %). The above olefin monomer is allowed to contain, together with the α-olefin, when necessary, a monomer having a carboxyl group, ester group, hydroxyl group, ethoxy group, sulfonyl group, or the like.

The Fischer-Tropsch wax is a synthetic hydrocarbon having 16 to 78 carbon atoms obtained from distillation residues of hydrocarbon synthesized from a synthetic gas consisting of carbon monoxide and hydrogen or obtained by hydrogen addition to the distillation residues.

The paraffin wax is a wax containing linear hydrocarbon having 20 to 40 carbon atoms, as a main component, separated and refined from vacuum distillation distillate oil of petroleum. Also, the microcrystalline wax is a wax containing branched chain hydrocarbon having 30 to 60 carbon atoms separated and refined from vacuum distillation residual oil or from heavy distillate oil of petroleum as a main component. The petrolatum is a viscous semisolid wax containing much oil separated from vacuum distillation residual oil of petroleum. Moreover, the ozokerite is a wax containing, as a main component, hydrocarbon mined from a petroleum deposit of the Tertiary formation existing in the vicinity of the petroleum deposit and its refined substance product is selecin.

Out of these aliphatic hydrocarbon waxes, the low-molecular-weight polyolefin wax, Fischer-Tropsch wax, paraffin wax, and microcrystalline wax are preferably used and the low-molecular-weight polyolefin wax is more preferably used.

The example of the fatty acid ester wax includes a carnauba wax containing, as a main component, fatty acid having 24 to 32 carbon atoms collected from leaves of a palm tree in Brazil and alcohol of esters, a candiria wax containing, as a main component, fatty acid having 30 and 32 carbon atoms collected from a watery plant in southern parts of the North America, alcohol and their esters, a rice wax containing, as a main component, fatty acid having 16 to 32 carbon atoms collected from rice bran oil and obtained, when required, by hydrogen addition and alcohol of esters, a bees wax containing, as a main component, fatty acid having 16 to 32 carbon atoms collected from honey cells and alcohol of esters, and hydrocarbon, a montan wax, as a main component, containing fatty acid having 20 to 32 carbon atoms obtained by extracting a non-carbonized plant wax from peat and/or brown coal and alcohol of esters, and rein, or the like. Moreover, the example of the synthetic fatty acid ester wax includes an ester of polyhydric alcohol such as glycerol, sorbitol, or the like. Out of these fatty acid ester waxes, from a viewpoint of a good low-temperature fixing property, the carnauba wax is preferably used.

The example of the fatty acid wax includes saturated linear fatty acid having about 16 to 30 carbon atoms such as myristic acid, palmitic acid, stearic acid, arachic acid, behenic acid, montanic acid. or the like, an unsaturated fatty acid having about 18 to 30 carbon atoms such as elaidic acid, eleostearic acid, vanillin acid, brassillic acid, or the like, fatty acid metal salt such as calcium laurate, calcium stearate, zinc stearate, magnesium stearate, or the like. The example of the fatty acid alcohol wax includes saturated fatty acid monohydric alcohol having about 16 to 34 such as cetyl alcohol, stearyl alcohol, arachyl alcohol, behenyl alcohol, carnaubyl alcohol, ceryl alcohol, melissyl alcohol, fatty acid polyhydric alcohol such as sorbitol or the like.

The example of the carboxylic acid wax includes aliphatic amides such as linoleic acid amide, oleic acid amide, lauric acid amide, saturated fatty acid bis-amides such as methylene bis-stearic acid amide, ethylene bis-capric acid amide, hexamethylene bis-stearic acid amide, m-xylene bis-stearic acid amide, unsaturated fatty acid bis-amides such as ethylene bisoleic acid amide, and fatty-acid alcohol bis-amides such as N,N′-dioleyl adipic acid amide, N,N-dioleyl sebacic acid amide, and N,N′-distearyl isophtharic acid amide.

According to the present invention, the above waxes may be used, when necessary, by oxidizing, hydrogenating, or hydrolyzing, or may be used as a derivative obtained by grafting a vinyl monomer onto these waxes, or as a mixture of these waxes, and their derivatives and mixtures obtained by mixing, as appropriate, these waxes with other components.

The waxes in the present invention can be used in the form of aqueous dispersed liquid obtained by dispersing the waxes in an aqueous medium, as appropriate, by using a known method, that is, the waxes can be used as, so called “wax emulsions.” The product example of the emulsions based on the low-molecular-weight polyolefin wax includes “Hytec E-4A, E-4B, E-68A, E-103N, E-433N, E-1000, E-6000, E-6500, E-7058, P-5043, P-5060, S-3121, S-3127, S-3148, S-8512” (produced by TOHO Chemical Industry, Co., Ltd.), “Chemipearl WP100, W100, W200, W300, W308, W400, W401, W410, W500, W700, W800, W900, W950, W4005, WF640” (produced by Mitsui Chemical, Inc.) and “BONDWAX WE-65” (produced by Konishi Co., Ltd.), all of which can be used suitably as waxes that can be applied to the present invention.

The mixing amount of each of these waxes is generally within a range of 0.1 to 10 weight parts, as an effective component amount, with respect to 100 weight parts of the total mixture containing the low-molecular-weight resin and high-molecular-weight resin as resin components, and preferably within a range of 1 to 8 weight parts. Moreover, the mixing amount of these waxes varies depending on a kind/type or amount of a pigment to be mixed at a time of producing the toner. When carbon black is used as the pigment, the mixing amount of these waxes is within a range of 1 to 4 weight parts, as an effective component amount, with respect to 100 weight parts of the total resin components. When magnetite or the like is used, the mixing amount of these waxes preferably is within a range of 2 to 6 weight parts as an effective component amount. From another view of point, the mixing rate is generally within a range of 0.1 to 6 weight parts with respect to 100 weight parts of the resin components, pigment, charge controlling agent described later and preferably within a range of 0.5 to 4 weight parts.

It is preferable that the mixing amount of the waxes is above each of the above lower limit values and, if so, an excellent off-set suppressing effect can be obtained. On the other hand, it is preferable that the mixing amount of the waxes is below each of the above upper limit values and, if so, long time storage of toner to be obtained is made possible and a filming phenomenon can be suppressed since a dispersion property of other toner mixture is not decreased and, further, the inconvenience of a decrease in toner fluidity and in image characteristics is hard to occur.

Moreover, the method of adding the waxes in the mixing step (1) of the present invention includes a method by which the waxes are added in a flake-like, powder-like, particle-like, or block-like solventless and solid state, a method by which the waxes are added in a solventless and fused state, a method by which the waxes are added in an aqueous dispersed liquid form, or the like. In addition to these, a method by which a mixture obtained by mixing, in advance, the aqueous dispersed liquid of the waxes with the low-molecular-weight resin aqueous dispersed liquid and/or high-molecular-weight resin aqueous dispersed liquid is added, and a method by which the mixture of the aqueous dispersed liquid is added in the form of aqueous sludge. Out of these adding methods, when the waxes are in a solventless and solid state, from a viewpoint that the waxes can be continuously and quantitatively fed to a mixing machine, the addition of the waxes in a fused state is preferable. Moreover, when the waxes are in the aqueous dispersed liquid form, from a viewpoint that the waxes can be well dispersed in the resin compared with the method by which the waxes are added singly and that variations in an added amount of the waxes can be made small when the waxes are fed continuously, the method by which the mixture obtained by mixing, in advance, the aqueous dispersed liquid of the waxes with the low-molecular-weight resin aqueous dispersed liquid and/or high-molecular-weight resin aqueous dispersed liquid is added is preferable. More preferably, the waxes are added in a state in which each of the high-molecular-weight resin and waxes dispersed in the aqueous dispersed liquid is mixed in advance.

In the mixing step (1) of the present invention, the materials containing the low-molecular-weight resin, high-molecular-weight resin, and waxes are mixed while being stirred by a mechanical or other way. By performing the step (1), preferably, at a temperature being higher than the glass transition point of the above low-molecular-weight resin and, more preferably, at a temperature being 20° C. higher than the glass transition point, it is possible to uniform the compositions of the mixture of the low-molecular-weight resin, high-molecular-weight resin, and waxes and, to improve various properties of the toner produced by using the mixture as a binder resin for the toner.

These advantages achieved by carrying out the mixing step (1) are thought to be owing to the reason that the action is promoted during the step (1) at the above temperature in which resin particles in the aqueous dispersed liquid being the suitable form of the high-molecular-weight resin or in the aqueous sludge derived from the aqueous dispersed liquid of the high-molecular-weight resin or fine particles resulting from the resin particles, low-molecular-weight resin in the form of solventless resin or resin solution or in the aqueous dispersed liquid form, and waxes in the solventless and solid state, or in the solventless fused state or in the form of the aqueous dispersed liquid are in contact with one another or particles dispersed in the mixed aqueous dispersed liquid or the aqueous sludge of the high-molecular-weight resin, low-molecular-weight resin, waxes which are mixed, in advance, in the form of the aqueous dispersed liquid are further in close contact with one another and these materials are mixed in the dispersed state.

The mixing step (1) may be performed in a released or sealed state under ordinary pressure or in a sealed pressure state to suppress evaporation and volatilization of volatile components such as water and organic solvent.

According to the process of the present invention, the above mixing step (1) and, simultaneously therewith and/or thereafter, the volatile component removing step (2) are performed. The volatile component removing step (2) is a process of removing, by evaporation, most volatile components such as water and organic solvent from the mixture produced by the mixing step (1). By this step (2), a solventless resin mixture from which 80% or more, preferably 95% or more, more preferably 99% or more of the volatile component is removed by evaporation is obtained. In this step (2), for example, volatile impurities such as a residual monomer contained in the mixture can be removed at the same time.

The step (2) can be performed by heating the resin mixture obtained in the mixing step (1) up to a temperature exceeding an evaporation equilibrium temperature of the volatile component and can be more effectively carried out by reducing the applied pressure in a heated state. When the volatile component is to be removed under ordinary pressure, immediately after the mixing of the low-molecular-weight resin, the high-molecular-weight resin, and the waxes, the temperature to volatize the resin mixture may be set to be a boiling point of a main substance being a medium in which each of the high-molecular-weight resin, the low-molecular-weight resin and the waxes is contained, which makes up the volatile component. In the present invention, the temperature may be suitably set to be a temperature near to a boiling point of water, however, the temperature is raised with progression of the removal of the volatile component. The step (2) may be performed after the completion of the step (1), however, simultaneous operations of both the step (1) and the step (2) are effective and, therefore, preferable.

At the same time when the volatile component removing process (2) is started, the volatile components such as water or the like contained in the resin mixture begin to decrease and finally the most volatile components are removed. When the volatile component removing step and the mixing step are simultaneously performed, at the same time when the mixing process is started, the evaporation of volatile component contained in the mixture and decreasing of the volatile component start.

To uniform compositions of the mixture of the low-molecular-weight resin, high-molecular-weight resin, waxes, after the mixing step (1) and the volatile component removing step (2), the step (3) in which the substantially solventless resin mixture from which the most volatile components have been removed is further kneaded by a mechanical way (hereinafter this step being called a kneading step (3)) is preferably performed. If a small amount of the volatile component resides, the kneading step may be carried out under the condition to remove more volatile components. It is preferable that the kneading step (3) is performed when at least one component making up the low-molecular-weight resin, the high-molecular-weight resin, and the waxes is in a fused state, which enables the mixture have more uniformed compositions to be obtained.

The inventors of the present invention have found that the odor occurring at a time of fixing for a printer or copying machine when the obtainable resin mixture is used as the binder resin for toner, can be remarkably reduced by performing the mixing step (1), the volatile component removing step (2), and the kneading step (3) to be carried out, when necessary, in an atmosphere of inert gas such as nitrogen, argon or the like having neither affinity nor reactivity to any one of the high-molecular-weight resin, low-molecular-weight resin, waxes, and solvent to be used together with these materials in some cases and that volatile impurities such as residual monomers and solvents contained in the resin mixture can be more effectively removed by carrying out these processes in a sealed state while the inert gas is made to be flowing.

The above mixing step (1), the removing step (2), and the kneading step (3) to be, if necessary, carried out are not limited to any specified means and any means can be employed so long as these steps can be performed without any inconvenience and, thus, these steps can be carried out by using at least one means having heating, kneading and/or volatile component removing functions.

The example of the preferable means to achieve the above functions includes a heating kneader, bambury mixer, roll mill, uniaxial continuous kneader, biaxial continuous kneader, continuous mixing solvent removing machine, drying machine, or the like. The use of the uniaxial continuous kneader or biaxial continuous kneader is preferable from a viewpoint that these steps (1) to (3) can be continuously performed and can be carried out effectively by one machine.

Various types of the biaxial continuous kneaders are available, however, it is preferable to use the biaxial continuous kneader with two rotational shafts having self-cleaning properties with a plurality of paddles being fixed thereto or two screws having the self-cleaning properties in which the paddles are made to rotate in a manner to be inscribed in a body of the kneading machine and the biaxial paddles facing each other are made to rotate in a state to be in contact with each other, from a viewpoint that it can provide a high kneading effect and good workability. The preferable biaxial continuous kneading machine is one which can transfer, by the rotation of the paddles or screws, fluid with its viscosity of 10 to 108 mPa·s from a feeding port to discharging port. The biaxial continuous kneading machine described above is already known and includes, for example, the KRC kneader (product name; manufactured and distributed by KURIMOTO, Co., Ltd.).

Moreover, the above “self-cleaning property” denotes a property that almost no mixture sticks to the paddles or screws in a residual state and no special washing process is required after use.

With the use of the above machine, the low-molecular-weight resin, high-molecular-weight resin, and waxes are mixed by the rotation of the screws or paddles secured to stirring shafts of the machine to achieve the mixing step (1) and kneading step (3). The volatile component removing step (2) can be performed ordinarily by heating the mixture at a temperature exceeding an evaporation equilibrium temperature of a main volatile component contained in the mixture by using a heating jacket or electric heater attached to the machine and can be effectively carried out by making inert gas flow in addition to heating or reducing pressure within the machine.

As another method for removing the volatile component, a known so-called “flash method” in which, after the mixture is heated if necessary, the mixture is introduced into a pressure-reduced region in the machine to allow water to be evaporated can be employed to make the mixture be put into a substantially solventless state.

The mixing step (1) and volatile component removing step (2) may be performed by using a single machine or a plurality of different machines, however, the use of the single machine is preferable from a viewpoint of ease of operations and low costs.

Moreover, in the case where the kneading step (3) is performed after the mixing step (1) and the volatile component removing step (2), the mixing step (1), the volatile component removing step (2), and the kneading step (3) can be performed by using a machine plurality of different machines, or the mixing step (1) and the volatile component removing step (2) can be carried out by a single first machine and the kneading step (3) by another second machine, or the mixing step (1) is performed by a first machine and the volatile component removing step (2) and the kneading step (3) by another second machine. Also, the mixing step (1), the volatile component removing step (2) and the kneading (3) step may be performed by a single machine. Out of these methods, from a viewpoint that a highly uniformed solventless resin mixture is to be obtained, preferably, the mixing step (1) and the volatile component removing step (2) are carried out by a single first machine and the kneading step (3) by another second machine and, from a viewpoint of high workability, most preferably, the mixing step (1), the volatile component removing step (2) and the kneading step (3) are performed by a single machine.

In the case where the above mixing step (1) and the volatile component removing step (2) are performed by a single first machine and the kneading step (3) by another second machine, a water content of the resin mixture obtained from a discharging port of the first machine after the completion of the steps (1) and (2) is preferably 20 or less weight % and more preferably 5 or less weight %.

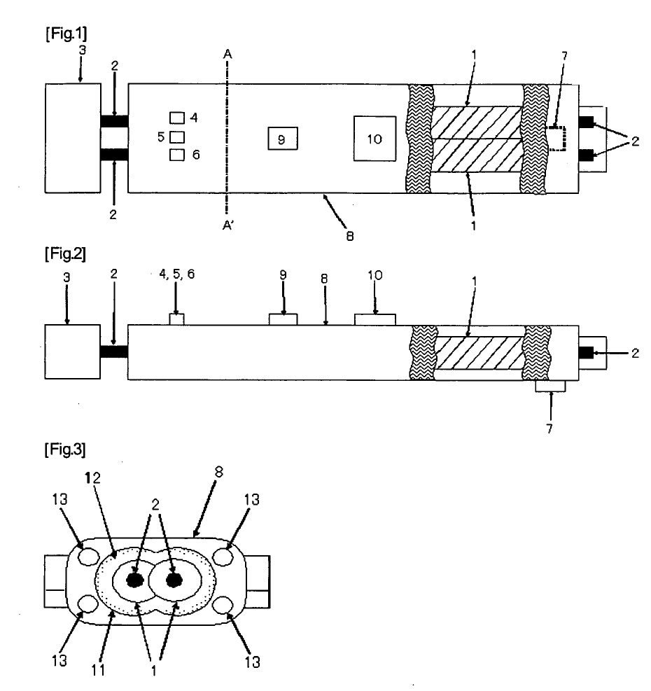

Hereinafter, the method of the present invention is described further in detail by referring to drawings. FIGS. 1 to 3 show schematically configurations of a sealed-type biaxial continuous kneader that can be used suitably in the present invention. FIG. 1 is a diagrammatic plan view of the kneader, FIG. 2 is a diagrammatic side view of the kneader, and FIG. 3 is a diagrammatic cross-sectional view of the kneader taken along the line A-A′ of FIG. 1.

Next, by referring to FIGS. 1 to 3, the mixing process, water removing process to be performed in parallel and then kneading process by using the sealed-type biaxial continuous kneader are described.

The biaxial continuous kneader is equipped with two rotational shafts 2 to which many paddles 1 are fixed and these paddles 1 are rotated by the motor 3 in an engaged state as shown in FIG. 3. The two rotational shafts 2 with many paddles 1 being fixed are sealed in a body 11 whose surrounding portions are covered by the heating jacket 8 and a cavity portion between a surface of each of the paddles 1 and an inner wall face of the body 11 serves as a mixing chamber 12. The heating jacket 8 is heated by the circulation of heated medium such as vapor, oil, or the like flowing through a tube 13 for the heated medium mounted within the heating jacket 8 and by an electric heater (not shown) or the like. The low-molecular-weight resin being the solventless resin in a fused state, high-molecular-weight resin in the form of the aqueous dispersed liquid, and the waxes in a fused state or in the form of the aqueous dispersed liquid are separately and continuously fed from material feeding ports 4 to 6 to the mixing chamber 12. Moreover, when both the high-molecular-weight resin and the waxes are in the form of the aqueous dispersed liquid, the mixture obtained, in advance, by mixing these materials can be poured into one of the material feeding ports 4 to 6 and, in this case, one of the material feeding ports 4 to 6 is simply closed. The supplied low-molecular-weight resin, the high-molecular-weight resin, and the waxes are heated, by heat fed from the heating jacket 8, up to a temperature exceeding a glass transition point of the low-molecular-weight resin and are then stirred and mixed in the mixing chamber 12 by rotation movement of the rotational shaft 2 and volatile components such as water are separated and the mixture is transferred to the resin mixture in a direction of the discharging port.

The processes of the supply and mixture of the low-molecular-weight resin, the high-molecular-weight resin, and the waxes, and removal of volatile components such as water described below are preferably performed in a sealed state and in the atmosphere of inert gas, which is introduced from an air introducing port 9, such as nitrogen being not reacted with the supplied material and produced mixture.

The volatile components such as water contained in the above supplied materials are discharged, together with the inert flowing gas such as nitrogen, from an evaporating port 10. Ordinarily, a supplying rate of the low-molecular-weight resin, the high-molecular-weight resin and the waxes is adjusted so that a cavity between the moving resin mixture and the inner wall of the body 11 occurs (not shown) and the evaporated volatile component is discharged, together with the introduced inert gas, through this cavity from the evaporating port 10.

Since a large amount of the volatile component such as water exists in the vicinity of the material feeding port 10, the temperature of the mixture is 100 to 110° C., however, with a decrease in the volatile component amount, the temperature of the mixture becomes high and finally the most volatile components contained in the mixture are removed and then the kneading step is performed, preferably, at a temperature at which the low-molecular-weight resin is fused. By this kneading step, the low-molecular-weight resin, the high-molecular-weight resin, and the waxes are further made uniform. Even in the resin fused region in the machine where the kneading step is performed, the residual volatile components are evaporated, together with the inert gas, from the evaporating port 10.

The resin obtained from the discharging port 7 is further introduced continuously, depending on aimed applications, to be worked so as to be of pellet- or flake-shaped.

When the mixing step, the volatile component removing step, and the kneading step are performed by using the biaxial continuous kneader in the way as described above, the conditions including the heating temperature of the heating jacket 8, staying time of the materials to be used for the mixing step, the volatile component removing step, and the kneading step in the machine, and others are determined depending on a kind or type of each of the low-molecular-weight resin, the high-molecular-weight resin, and the waxes, amount of the volatile component contained in supplied materials such as water content in the high-molecular-weight resins in the form of the resin aqueous dispersed liquid form, supplying speed of these material components into the kneader, flowing rate of inert gas, desired compositions and water content of the solventless resin mixture to be obtained from the discharging port 7, processing capacity of the kneader, and other factors. Therefore, the above conditions cannot be designated unconditionally, however, if only the above factors are specified, it is easy to set various conditions for the processes based on theory and experiment.

Generally, when a rate of removing a volatile component such as water is raised by a method of increasing a heating temperature, or the like, time required for the mixing process and water removing process is shortened and region for these processes is reduced and time for the kneading process is increased and the region for the kneading process is expanded.

When both the low-molecular-weight resin and the high-molecular-weight resin are, for example, a polystyrene resin and are in a solventless state and in the aqueous dispersed liquid form, the temperature of the heating jacket 8 can be set so as to be at 120 to 300° C., preferably at 160 to 250° C., and the time of these material components staying in the material feeding ports 4 to 6 to the discharging port 7 can be set so as to be at 1 to 60 minutes, more preferably 5 to 30 minutes.

In the apparatus having the evaporating port 10 for evaporating volatile components as in the above machine, if an aperture area of the evaporating port 10 is increased, the process of removing the volatile component from the resin mixture containing a large amount of water becomes effective. That is, it is preferable that, in the biaxial continuous kneader, the sum of the areas of the material feeding ports 4 to 6 and the aperture area of the evaporating port 10 both being mounted on an upper portion of the machine is within a range of 15 to 100% of the product of a length L of the body 11 and width D of the body 11, which enables effective water removing process. If the above value is 100%, it means that the biaxial continuous kneader is opened along a total length of the upper portion of its body 11, which is a preferable state. In this case, the heating can be achieved by mounting the heating jacket 8 not in the upper portion of the body 11 but in the lower portion only or by mounting a tube for a heat medium in the rotational shaft 2 or the paddle 1, without using the heating jacket 8, to make the heat medium circulate therein.

The obtained solventless resin mixture in pellet- or flake-shaped can be used as a binder resin that enables the production of sophisticated electrostatic charge image developing toner being excellent in an anti-offset property, fixing property, toner-spent preventing property, filming preventing property, anti-blocking (non-aggregating) property required in storage, development property required at a time of forming an image, and further being odorless.

The electrostatic charge image developing toner can be produced in a manner in which a colorant, if necessary, charge controlling agent, additive agent such as a parting agent are mixed with the binder resin for toner obtained thus for uniform mixing and fusion and then, after cooling the fused mixture, the mixture is ground coarsely when necessary and is pulverized finely by a jet mill or the like and is further classified by a particle classifier to obtain the toner having a desired particle diameter.

As the colorant described above, an inorganic pigment, organic pigment, and synthetic dye can be used and the inorganic pigment or organic pigment is preferably used. Moreover, one or more pigments and/or one or more dyes can be used in combination. The usage amount of the colorant is preferably 1 to 200 weight parts with respect to 100 weight parts of the binder resin for the toner and more preferably 3 to 150 weight parts.

The example of the above inorganic pigment includes a metal powder pigment such as zinc powder, iron powder, and copper powder, a metal oxide pigment such as magnetite, ferrite, red iron oxide, titanium oxide, zinc white, silica, chromium oxide, ultramarine, cobalt blue, cerulean blue, mineral violet, and trilead tetraoxide, a carbon pigment such as carbon black, thermatomic carbon, and furnace black, a sulfide pigment such as zinc sulfide, cadmium red, selenium red, mercury sulfide, and cadmium yellow, a chromate pigment such as molybdenum red, barium yellow, strontium yellow, and chromium yellow, and a ferrocyanide pigment such as Milori blue.

The example of the above organic pigment includes an azo pigment such as benzidine yellow, benzidine orange, permanent red 4R, pyrazolone red, lithol red, brilliant scarlet G, bon maloon light, an acid dye pigment obtained by precipitating an acid dye such as orange II, acid orange R, eoxin, quinoline yellow, tartrazine yellow, acid green, pecock blue, alkali blue using a precipitant, a basic dye pigment obtained by precipitating a basic dye such as rhodamine, magenta, macarite green, methyl violet, victoria blue using tannic acid, tartar emetic, phosphotungstic acid, phosphomolybdic acid, phosphotungstic molybdic acid, a mordant dye pigment such as metal salts of hydroxyanthraquinone, and alizarin madder lake, a phthalocyanine pigment such as phthalocyanine blue, and sulfonated copper phthalocyanine, quinacridone pigment such as quinacridone red, quinacridone violet, and carbazole dioxane violet, and a dioxane pigment.

The example of the synthetic dye includes an acridine dye, aniline black dye, anthraquinone dye, azine dye, azo dye, azomethine dye, benzo- and naphthoquinone dye, indigo dye, indophenol dye, indoanilin dye, indamine, leuco vat dye ester, naphthalimide dye, nigrosine dye, induline dye, nitro and nitroso dye, oxazine and dioxazine dye, dye oxide, phthalocyanine dye, polymethine dye, quinophthalone dye, sulfur dye, tri- and diallylmethane dye, thiazien dye, xanthene dye. Preferably, the aniline black dye, nigrosine dye, and azo dye are used. More preferably, an azo dye having salycylic acid, naphthoic acid, or 8-oxinoline residues in its molecule and forming complex salt with a metal such as chromium, copper, cobalt, iron, aluminum is used.

The example of the above charge controlling agent includes, as the agent for positive charging, a nigrosine electron-donative dye, metal salt of naphthenic acid or higher fatty acid, alkoxylated amine, quarterly ammonium salt, alkylamide, chelate, pigment, fluoride treatment activating agent, or the like, and includes, as the agent for negative charging, an electron-accepting organic metal complex, electron-accepting chelate compound, chlorinated paraffin, chlorinated polyester, acid radical excessively containing polyester, sulfonyl amine of copper phthalocyanine, or the like.

Additional fluidity improving agent may be added, if necessary, to the toner. Any fluidity improving agent can be added so long as the addition of the agent increases the fluidity. The example of the fluidity improving agent includes hydrophobic colloidal silica fine powder, colloidal silica fine powder, hydrophobic titanium oxide fine powder, titanium oxide fine powder, hydrophobic alumina fine powder, alumina fine powder, their powder mixture or the like.

The toner produced as above is suitably used, as a two-component developer consisting of toner and carrier, for a developer using a carrier having a layer coated with a resin. The typical carrier having the resin-coated layer is a carrier obtained by coating a surface of a carrier nuclidic particles made of, generally, iron, nickel, ferrite, and glass beads with a layer coated with an insulating resin. The example of the typical insulating resin materials includes, generally, a fluororesin, silicon resin, acrylic resin, stylene-acryl copolymerized resin, polyester resin, and polybutadiene resin.

The two-component developer containing the electrostatic charge image developing toner of the present invention and the carrier having the resin-coated layer are suitably used in a high-speed electrophotographic apparatus in that less toner-spent causing staining of the toner resulting in sticking of toner particles to surfaces of carrier particles occurs and friction-charging property between the toner and the carrier can be controlled and excellent durability of the toner enables a longer use life of the developer.

The application of the toner of the present invention is not limited to the two-component developer. The toner can be applied to one component developer using no carrier, for example, a magnetic one-component developer whose toner contains magnetic powder or a non-magnetic one-component developer whose toner does not contain magnetic powder.

In the production of the toner of the present invention, in addition to the binder resin used in the production, other binder resins such as a styrene resin and polyester resin can be used, in a blended manner, as an adjunctive component. Preferably, the adjunctive binder resin component makes up 30% or less in weight of the total binder resins.

According to the method for producing the electrostatic charge image developing toner of the present invention, the toner can be produced by mixing various additive agents described above together with the above low-molecular-weight resin, high-molecular-weight resin and waxes.

### EXAMPLES

The present invention is described by using examples, comparative examples, and producing examples in detail. The samples of the obtained toner were evaluated according to the following experimental methods.

1. Measurement of Residual Water

The measurement was made by using the Karl-Fischer type moisture meter “CA-05” and vaporizer “VA-05” (product name; manufactured by Dia-instrument Ltd.). The sample 0.5 g of the toner was weighed out accurately and poured into the vaporizer VA-05 to measure an amount of water residing in the toner by a specified method.

2. Measurement of Residual Monomer

An amount of a monomer residing in the binder resin mainly causing the occurrence of odor of the toner was measured by the following method. A gas chromatography (GC) apparatus “GC-14A” (product name; manufactured by SHIMADZU Ltd.) equipped with columns “DB-WAX” (product name; manufactured by J&W Scientific Co., Ltd) was used for the measurement. The sample of the binder resin was dissolved in chloroform so that its concentration is 2.5 weight %. The dissolved liquid was filtered and 3 μL of the filtered liquid was obtained which was put into the chromatography apparatus for the measurement. Moreover, the concentration of the monomer in the sample was calculated using a calibration curve prepared separately.

3. Measurement of Toner Particle Diameter

After the sample of the toner was added to the electrolysis solution “ISOTON R-II” (product name; produced by Coulter Scientific Japan Ltd) and dispersed thoroughly, the dispersed liquid was adjusted so that its concentration became about 5% by using the densitometer “Coulter counter TA-II” (product name; manufactured by Beckman Coulter Ltd.) and volume average particle diameters of the toner were measured by a specified method by using the “Coulter counter TA-II”.

4. Toner Storage Property

The magnetic and non-magnetic toner was placed into a 100 ml polyethylene bin and a lid was put on the bin firmly. The bin containing the toner was allowed to stand for 16 hours under the condition of temperature being 50° C. and then the storage property was measured under severe conditions by using the “Hosokawa micron powder tester PT-E” (product name; manufactured by Hosokawa Micron Corporation.). Further, the sample was put on a sieve with a mesh size of 350 μm and was vibrated to measure a residual amount of the sample residing on the sieve. The value of the residual amount of the sample was used, as a value of aggregate residual amount of the toner, in the following formula to perform the following evaluation based on the residual amount.

$$Aggregate residual rate ( \% ) = \frac{Total amount ( g ) of toner left after vibration}{Total amount ( g ) of toner put on sieve} \times 100 \qquad [ Formula 1 ]$$

⊚: The aggregate residual rate is less than 50%.

◯: The aggregate residual rate is above 50% and less than 70%.

Δ: The aggregate residual rate is above 70% and less than 90%.

x: The aggregate residual rate is 90% or more.

5. Printing Test 1 (Non-Magnetic Toner)

By using the sample obtained by mixing 5 weight parts of the non-magnetic toner sample with 95 weight parts of the silicon-resin coated carrier “F141-1030” (product name; manufactured by Powder Tech Co., Ltd.) and by modifying a temperature setting of the image fixing section of the commercially-available high-speed copying machine “Konica Sitios 7075” (product name; copying speed 75 sheets/minutes, Sharp Co., Ltd.) so as to be operated at variable temperatures, the test of printing an image chart occupying 5% of an image area of common copy paper (75 g/m₂) was executed.

5-1. Image Fixing Test

A fixing temperature of the image fixing section was set from 130° C. to 200° C., an image fixing test was carried out, an image fixation enabling temperature was measured.

5-2. Anti-Offset Property Test

After a fixing temperature of the image fixing section was set at 200° C. and continuous printing on 1000 sheets of paper was carried out, an image was printed on white paper and a degree of staining on the white paper and on the heated roll caused by the toner off-set were observed visually to evaluate the anti-offset property of the toner.

∘: Neither staining on white paper nor staining on heated roll.

Δ: No staining on white paper but slightly staining on heated roll.

x: Staining on white paper.

5-3. Printed Character/Images Adhering Test

After an adhesive surface of the “Scotch mending tape” (product name; produced by SUMITOMO 3M Co.) was made to be in contact with a surface of printed characters/images on the 1000^{th} sheet of paper obtained from the above continuous printing described in the above (5-2) paragraph and a circumferential part of a disk having a weight of 1 kg and width of 16 mm was made to be in contact with the tape in a struck manner for an operation of reciprocating the disk once, the scotch mending tape was then peeled off from the surface of printed characters/images to measure image density obtained before sticking of the tape and after peeling-off of the tape by using the “Macbeth reflection densitometer” (product name; manufactured by Macbeth Coulter Corp.) and, based on fixation values of the printed characters/images calculated from the result of the measurement by using the following formula, the printed characters/images adhering property of the sample toner to the common copy paper was evaluated as follows.

$$Fixing rate ( \% ) = \frac{Image density after peeling \text{-} off of tape}{Image density before sticking of tape} \times 100 \qquad [ Formula 2 ]$$

∘: Fixing rate being above 95%.

Δ: Fixing rate being 90% or more and less than 95%.

X: Fixing rate being less than 90%.

5-4. Continuous Printing Test

After a fixing temperature of the image fixing section was set at 200° C. and continuous printing on a hundred thousand sheets of paper was carried out, by reviewing a degree of a toner filming phenomenon to a photoconductor drum and a state of final printed images obtained after the completion of the continuous printing, the anti-offset property and final state of printed images were evaluated according to the following evaluation criteria.

Evaluation criteria of filming preventing property

∘: No toner filming to photoconductor drum.

Δ: A little toner filming to photoconductor drum, however, no influence on images.

x: Much toner filming to photoconductor drum and with image problems.

State of finally printed images—comparative observation of images initially printed on five sheets of paper and images finally printed on five sheets of paper.

∘: No difference between initially printed images and finally printed images and neither staining nor fogging and sharp.

Δ: A little staining and fogging, however, no influence on images.

x: Much staining and fogging with practical image problems.

6. Printing Test 2 (Magnetic Toner)

By using a sample of the magnetic toner and by modifying the commercially-available laser printer “Laser Jet 5” (product name; printing speed 12 sheets/minute, manufactured by Hewlett-Packard Co.) to attach an external fixing device so that fixing is enabled at variable temperature, the test of printing an image chart occupying 5% of an image area of common copy paper (75 g/m₂) was executed.

6-1. Image Fixing Test

A fixing temperature of the image fixing section was set from 130° C. to 200° C., an image fixing test was carried out and an image fixing enabling temperature was measured.

6-2. Anti-Offset Property Test

After a fixing temperature of the image fixing section was set at 200° C. and continuous printing on 1000 sheets of white paper was carried out, by visually observing a degree of staining on the white paper and a degree of staining of the heated roll caused by the toner offset, the anti-offset property was evaluated according to the following evaluation criteria.

∘: No staining on both white paper and heated roll.

Δ: No staining on white paper but slight staining on heated roll.

x: Staining on white paper.

6-3. Printed Character/Images Adhering Property Evaluation Test

The same test as in the above (5-3) paragraph was carried out except that printed characters/images on the 5^{th} sheet obtained by the continuous printing done in the above (6-2) paragraph are used and a fixing rate value of printed characters/images was calculated by using the same formula as employed in the above (5-2) paragraph to evaluate the printed characters/images adhering property of the sample toner to the common copy paper was evaluated according to the same evaluation criteria.

∘: Fixing rate being above 95%.

Δ: Fixing rate being 90% or more and less than 95%.

x: Fixing rate being less than 90%.

6-4. Printed Images State Evaluation Test

States of images printed on five sheets of paper obtained by the continuous printing described in the above (6-2) paragraph were observed and the final printed image states were evaluated according to the following evaluation criteria.

∘: No difference from initially printed images with neither staining nor fogging and being sharp.

Δ: Slight staining and fogging, however, no practical problems.

x: Much staining and fogging with many practical problems.

[Production of Low-Molecular-Weight Resin]

### Production Example 1

By continuously adding, in 30 minutes, a mixture solution of monomers obtained by uniformly mixing 100 weight parts of styrene (St) with 0.5 weight parts of di-t-butylperoxide and by further allowing the solution to keep at 210° C. for 30 minutes to perform bulk polymerization in an autoclave equipped with an agitator, heating device, cooling device, thermometer, and dropping pump and being controlled so that a temperature within the autoclave is kept at 210° C., a solventless low-molecular-weight styrene resin was obtained. A molecular weight peak value MP_{L} of the obtained low-molecular-weight resin was 4,500 and its weight-average molecular weight Mw_{L} was 5,100, its number-average molecular weight Mn_{L} was 2,400 and a ratio of Mw_{L} to Mn_{L} (Mw_{L}/Mn_{L}) was 2.1.

[Production of High-Molecular-Weight Resin]

### Production Example 2

After weighing out 27 weight parts of deionized water and 1 weight part of the anionic emulsifier “Neogen R” (product name; sodium dodecylbenzensulfonate, produced by Dai-ichi Kogyo Seiyaku Co., Ltd.) and stirring and dissolving in a container equipped with an agitator and heating device, by stirring the dissolved liquid while a monomer mixture solution consisting of 75 weight parts of St, 25 weight parts of butyl acrylate (BA) and 0.05 weight parts of divinyl benzene (DVB) is being dropped, a monomer emulsified liquid is obtained.

Next, 120 weight parts of deionized water were weighed out and put into a pressure-proof reaction container equipped with an agitator, pressure gage, thermometer, dropping pump and air within the container was replaced with nitrogen gas and then the temperature within the container was raised up to 80° C. and 15 weight % of the above monomer emulsified liquid was added and, further, 1 weight part of an aqueous solution of 2 weight % of potassium persulfate was added to the liquid to perform initial polymerization at 80° C. After the completion of the initial polymerization, the temperature within the container was raised up to 85° C. and the remaining monomer emulsified liquid and 4 weight parts of the aqueous solution of 2 weight % of potassium persulfate were added together in 3 hours and, then, the temperature of the container was held at 85° C. to perform emulsion polymerization and, as a result, a styrene acrylic resin aqueous dispersed liquid having an average particle diameter of 130 nm and its solid content concentration of 40 weight % was obtained.

The polymerization reaction proceeded in a stable manner and the resulting polymerization conversion rate of the obtained resin was high. After resin were separated from the resin aqueous dispersed liquid by using an ultracentrifugal separator, a molecular weight of the resin was measured by the gel permeation chromatography (GPC) apparatus and, as a result, its weight-average molecular weight (Mw_{H}) was 970, 000 and its molecular weight peak value (Mp_{H}) was 720,000.

[Production of Low-Molecular-Weight Resin]

### Production Example 3

After air within an autoclave equipped with an agitator, heating device, cooling device, thermometer, and dropping pump was replaced with nitrogen gas, with the temperature within the autoclave being kept at 160° C., a monomer mixture solution obtained by mixing 100 weight parts of styrene, 50 weight parts of xylene, and 2.0 weight parts of di-tertiary-butyl peroxide was continuously added, in 30 minutes, into the autoclave. After the completion of the addition, while the temperature within the autoclave was kept at 160° C., the monomer mixture solution was allowed to keep for further 2 hours to perform solution polymerization and then was cooled and, as a result, the resin solution was obtained. The solid content concentration of the obtained resin solution was 65% and its molecular weight peak Mp was 4,200 and its weight-average molecular weight Mw was 4,800.

[Production of High-Molecular-Weight Resin]

### Production Example 4

First, 100 weight parts of an aqueous dispersed liquid of the resin obtained in the Production example 2 and 50 weight parts of deionized water were weighed out and put into a container equipped with a desper and dropping pump and were mixed and then 20 weight parts of an aqueous solution of 2 weight % of calcium chloride was added to the mixture liquid while being stirred at high speed. After the resulting mixture liquid was allowed to stand, its supernatant liquid was removed and, after water was again added to the mixture liquid to be dispersed, and water was removed and washed by a filter press and, after impurities were removed, water was again added to be dispersed and, as a result, sludge containing 54% of solid contents was obtained.

[Production of Binder Resin for Electrostatic Charge Image Developing Toner]

### Example 1

By continuously adding 60 weight parts of the low-molecular-weight resin (about 60 weight parts as an effective component) produced in the production example 1, and the mixture obtained by mixing, in advance, 100 weight parts of the high-molecular-weight resin aqueous dispersed liquid (about 40 weight parts as an effective component) produced in the production example 2, and 5 weight parts (about 2 weight parts as an effective component) of “BONDWAX WE-65” (product name; paraffin wax emulsion, softening point of wax being 80° C., effective component being 40 weight %, produced by Konishi Co., Ltd.) into the continuous kneader “KRC kneader” (product name; manufactured and distributed by KURIMOTO Co., Ltd.) schematically shown in FIGS. 1 to 3, with a jacket temperature being set at 200° C., from each of different material supplying ports (for example, reference numbers 4 and 6 in FIG. 1) and, by performing simultaneous heating and mixing operation and by letting water and solvent be evaporated to be removed, the solventless binder resin for electrostatic charge image developing toner containing uniformly mixed waxes was obtained. An operating speed of the continuous kneader was set so that the time required to obtain 1 kg of the binder resin was about 20 minutes when the above process is performed. Amounts of water and monomers still residing in the obtained binder resin were measured by the measurement method described above and, as a result, the amount of the residual water was 0.1 or less weight % and the amount of the monomer contained in the binder resin was 90 ppm.

### Example 2

### Example of Using Low-Melting Point Solid Wax in Fused State

By continuously adding 60 weight parts (about 60 weight parts as an effective component) of the low-molecular-weight component produced in the above production example 1, 100 weight parts (about 40 weight parts as an effective component) of the high-molecular-weight resin dispersed liquid prepared in the above production example 2, and wax “HNP-10” (product name; paraffin wax, softening point of wax being 80° C., 100 weight % as effective component, produced by Nippon Seiro Co., Ltd.), which was fused in advance at 150° C., into the continuous kneader “KRC kneader” (product name; manufactured and distributed by KURIMOTO Co., Ltd.) schematically shown in FIGS. 1 to 3, with a jacket temperature being set at 200° C. and an operating speed of the continuous kneader being set the same condition as in the example 1, from each of different material supplying ports, and by performing simultaneous heating and mixing operation and by letting water and solvent be evaporate to be removed, the solventless binder resin for electrostatic charge image developing toner containing uniformly-mixed wax was obtained. Amounts of water and monomer still residing in the obtained binder resin were measured by the measurement method described above and, as a result, the amount of the residual water was 0.1 or less weight % and the amount of the monomer residing in the binder resin was 110 ppm.

### Examples 3

The solventless binder resin for electrostatic charge image developing toner was obtained by the same method as employed in the Example 1 except that 5 weight parts (about 2 weight parts as an effective component) of “Hytec P-5060S” (product name; low-molecular-weight polypropylene wax emulsion, softening point of wax being 145° C., effective component being 40 weight %, produced by TOHO CHEMICAL INDUSTRY, Co., Ltd.)(P-5060) was used instead of using the 5 weight parts (about 2 weight parts as an effective component) of “WE-65” employed in the Example 1. Amounts of water and monomer still residing in the obtained binder resin were measured by the measurement method described above and, as a result, the amount of the residual water was 0.1 or less weight % and the amount of the monomer residing in the binder resin was 100 ppm.

### Examples 4-7 and Comparative Example 1

The solventless binder resin for electrostatic charge image developing toner was obtained by the same method as employed in the Example 3 except that the mixing amount of the wax “P5060” used in the Example 3 was changed for use or this wax emulsion was not used. Table 1 shows an mixing amount (as effective components) of each of the low-molecular-weight resin, high-molecular-weight resin and wax “P5060”, and residual water content in obtained binder resin and residual monomer content.

### Examples 8-9

The binder resin for electrostatic charge image developing toner was obtained by the same method as employed in the Example 1 except that 5 weight parts (about 2 weight parts as an effective component) of “Chemipearl WP100” (product name; low-molecular-weight polypropylene wax emulsion, softening point of wax being 148° C., effective component being 40 weight %, produced by Mitsui Chemical Corp.) (WP100) or 2 weight parts (about 2 weight parts as an effective component) of “Viscoal 330P” (product name; low-molecular-weight polypropylene wax, softening point of wax being 152° C., effective component 100 weight %, produced by Sanyo Chemical Industries, Ltd.) (V330P) were used instead of using 5 weight parts (about 2 weight parts as an effective component) of WE-65 employed in the Example 1. Table 1 shows kinds or types of the used waxes, mixing amount of the waxes (effective component amount), residual water content in the obtained binder resin and the residual monomer content.

### Example 10

The binder resin for electrostatic charge image developing toner was obtained by the same method as employed in the Example 1 except that 92 weight parts (about 60 weight parts as an effective component) of the low-molecular-weight resin solution produced by the method employed in the production example 1 were used instead of using 60 weight parts of the low-molecular-weight resin (about 60 weight parts as an effective component) and an operation speed of the continuous kneader was set so that the time required to obtain 1 kg of the binder resin for toner was about 40 minutes. Amounts of water and monomer residing in the obtained binder resin were measured by the measurement method described above and, as a result, the amount of the residual water was 0.1 or less weight % and the amount of the monomer residing in the binder resin was 100 ppm and the amount of the residual solvent was 2500 ppm.

### Example 11

The binder resin for electrostatic charge image developing toner was obtained by the same method as employed in the Example 1 except that 74 weight parts (40 weight parts as an effective component) of sludge of the high-molecular-weight resin produced by the method employed in the production example 4 instead of using 100 weight parts (about 40 weight parts as an effective component) of the aqueous dispersed liquid of the high-molecular-weight resin by the method employed in the Example 1. Amounts of water and monomer residing in the obtained binder resin were measured by the measurement method described above and, as a result, the amount of the residual water was 0.1 or less weight % and the amount of the monomer residing in the binder resin was 110 ppm.

TABLE 1
Composition and characteristic value of binder resin for electrostatic charge image developing toner

| | Item | | | | | | | | |
|---|---|---|---|---|---|---|---|---|---|
| | Composition | | | | | | | | |
| | Low-molecular-weight resin | | High-molecular-weight resin | | Waxes | | | characteristic value | |
| | | Mixing | | Mixing | | | Mixing | Residual | |
| | | amount | | amount | | Melting | amount | water | Residual |
| | | (weight | | (weight | | point | (weight | content | monomer |
| Experiment No. | Kind or type | part) | Kind or type | part) | Kind or type | (° C.) | part) | (weight %) | (ppm) |
| Example 1 | Production example 1 | 60 | Production example 2 | 40 | WE-65 | 80 | 2 | ≦0.1 | 90 |
| Example 2 | Production example 1 | 60 | Production example 2 | 40 | HNP-10 | 80 | 2 | ≦0.1 | 110 |
| Example 3 | Production example 1 | 60 | Production example 2 | 40 | P5060 | 145 | 2 | ≦0.1 | 100 |
| Comparative | Production example 1 | 60 | Production example 2 | 40 | — | — | 0 | ≦0.1 | 105 |
| example 1 | | | | | | | | | |
| Example 4 | Production example 1 | 60 | Production example 2 | 40 | P5060 | 145 | 0.5 | ≦0.1 | 90 |
| Example 5 | Production example 1 | 60 | Production example 2 | 40 | P5060 | 145 | 1 | ≦0.1 | 95 |
| Example 6 | Production example 1 | 60 | Production example 2 | 40 | P5060 | 145 | 5 | ≦0.1 | 110 |
| Example 7 | Production example 1 | 60 | Production example 2 | 40 | P5060 | 145 | 9 | ≦0.1 | 100 |
| Example 8 | Production example 1 | 60 | Production example 2 | 40 | WP100 | 148 | 2 | ≦0.1 | 100 |
| Example 9 | Production example 1 | 60 | Production example 2 | 40 | V330P | 152 | 2 | ≦0.1 | 95 |
| Example 10 | Production example 3 | 60 | Production example 4 | 40 | WE-65 | 80 | 2 | ≦0.1 | 150 |
| Example 11 | Production example 1 | 60 | Production example 2 | 40 | WE-65 | 80 | 2 | ≦0.1 | 110 |

[Production of Non-Magnetic Toner]

### Example 12

After each of 100 weigh parts of the solventless electrostatic charge image developing toner obtained in the Example 1 and 6 weight parts of carbon black “MA-100” (product name; produced by Mitsubishi Chemical Corp.), 2 weight parts of azo iron complex “T-77” (product name; produced by HODOGAYA CHEMICAL Co., Ltd.) was put into the “Henchel mixer FM5C/1” (product name; manufactured by MITSUI MINING Co., Ltd.) and mixed with one another, the mixture was fused and kneaded by using the biaxial kneading/extruding machine “KRCS1 kneader” (product name; KURIMOTO, Co., Ltd.). After being cooled, the mixture was pulverized coarsely by using the hammer crusher “VC-210” (product name; HORAI Co., Ltd.) and then pulverized finely by using the jet mil “LJ-N” (product name; produced by Nippon Neumatic Mfg. Co., Ltd.). Further, after the obtained finely pulverized powder was classified by using the wind-power pneumatic classifier “MDS-2” to obtain particles each having size of 5 to 2 μcm, 1 weight part of hydrophobic silica “TG-308F” (produced by Cabot Speciality Chemicals Inc.) was added to the powder to obtain non-magnetic toner.

By using the obtained toner, the above various tests were executed. Table 2 shows the toner properties such as an average particle diameter of toner and a toner storage property, and a result of various printing physical properties of the obtained toner according to the printing test 1.

### Example 13 to 21

The non-magnetic toner was obtained by the same method as employed in the Example 12 using the electrostatic charge image developing toner produced in the Examples 2 to 6 and the Examples 8 to 11 instead of using the binder resin for electrostatic charge image developing toner produced in the Example 1. By using the non-magnetic toner, various tests described above were executed. Table 2 shows compositions of the toner mixture, toner properties, and results of various printing physical properties of the toner in the printing test 1.

### Comparative Example 2

The non-magnetic toner was obtained by the method employed in the Example 12 except that 100 weight parts of the electrostatic charge image developing toner produced in the comparative example 1 were used instead of the binder resin for the electrostatic charge image developing toner produced in the Example 1 and that 5 weight parts of the polypropylene (PP) wax “Chemipearl WP-100” were added. By using the non-magnetic toner, various tests described above were executed. Table 2 shows compositions of the toner mixture, toner properties, and results of various printing physical properties of the toner in the printing test 1.

TABLE 2
Mixed composition of non-magnetic toner, characteristic value, and printing property

| | Item | | | | | | | | | | | |
|---|---|---|---|---|---|---|---|---|---|---|---|---|
| | Composition | | | | | Characteristic | | Printing property of toner | | | | |
| | Binder resin for toner | | | | | value of toner | | | | Printed | | |
| | | Mixing | Carbon | Azo iron | | Average | | Image fixing | | characters/ | Filming | |
| | | amount | black | complex | PP wax | particle | | enabled | Anti- | image | prevent- | Final |
| | | (weight | (weight | (weight | (weight | diameter | Storage | temperature | offset | adhering | ing | image |
| Experiment No. | Kind or type | part) | part) | part) | part) | (μm) | property | (° C.) | property | property | property | state |
| Example 12 | Example 1 | 100 | 6 | 2 | 0 | 9.6 | ⊚ | 130 | ◯ | ◯ | ◯ | ◯ |
| Example 13 | Example 2 | 100 | 6 | 2 | 0 | 9.7 | ⊚ | 135 | ◯ | ◯ | ◯ | ◯ |
| Example 14 | Example 3 | 100 | 6 | 2 | 0 | 9.5 | ⊚ | 140 | ◯ | ◯ | ◯ | ◯ |
| Comparative | Comparative | 100 | 6 | 2 | 5 | 9.8 | ⊚ | 160 | X | Δ | X | X |
| example 2 | example 1 | | | | | | | | | | | |
| Example 15 | Example 4 | 100 | 6 | 2 | 0 | 9.8 | ⊚ | 140 | Δ | ◯ | Δ | Δ |
| Example 16 | Example 5 | 100 | 6 | 2 | 0 | 9.9 | ⊚ | 140 | Δ | ◯ | Δ | Δ |
| Example 17 | Example 6 | 100 | 6 | 2 | 0 | 9.3 | ⊚ | 140 | ◯ | Δ | ◯ | ◯ |
| Example 18 | Example 8 | 100 | 6 | 2 | 0 | 9.6 | ⊚ | 150 | ◯ | ◯ | Δ | ◯ |
| Example 19 | Example 9 | 100 | 6 | 2 | 0 | 10 | ⊚ | 150 | ◯ | ◯ | Δ | ◯ |
| Example 20 | Example 10 | 100 | 6 | 2 | 0 | 9.5 | ◯ | 130 | Δ | ◯ | Δ | ◯ |
| Example 21 | Example 11 | 100 | 6 | 2 | 0 | 9.4 | ◯ | 130 | ◯ | ◯ | Δ | ◯ |

[Production of Magnetic Toner]

### Example 22

The magnetic toner having an average particle diameter of 10.0 μm was obtained by the same method as employed in the Example 12 except that 80 weight parts of the magnetite “BL-200” (product name; produced by Titan Kogyo Co., Ltd.) were used instead of using 6 weight parts of the carbon black “MA-100”. By using the obtained magnetic toner, property tests of the toner were executed according to the above toner storage property test and printing test 2. Table 3 shows a mixing composition of the magnetic toner and results of the tests.

### Examples 23 to 31

The magnetic toner was obtained by the same method as employed in the Example 22 by using the binder resin for electrostatic charge image developing toner produced in any one of the Examples 2 to 3 and 5 to 11 instead of using the binder resin for electrostatic charge image developing toner produced in the Example 1. By using the obtained magnetic toner, property tests of the toner were executed according to the above toner storage property tests and printing tests 2. Table 3 shows a mixing composition of the magnetic toner and results of the tests.

### Comparative Example 3

The magnetic toner was obtained by the same method employed in the Example 22 using 100 weight parts of the electrostatic charge image developing toner produced in the comparative examples 1 and 9 weight parts of the polypropylene wax “Viscoal 330P” instead of using the electrostatic charge image developing toner produced in the Example 1. By using the obtained magnetic toner, property tests of the toner were executed according to the above toner storage property test and printing test 2. Table 3 shows a mixing composition of the magnetic toner and results of the tests.

TABLE 3
Mixed composition of magnetic toner, characteristic value, and printing property

| | Item | | | | | | | | | | |
|---|---|---|---|---|---|---|---|---|---|---|---|
| | Composition | | | | | Characteristic | | Printing property of toner | | | |
| | Binder resin for toner | | | | | value of toner | | | | Printed | |
| | | Mixing | | Azo iron | | Average | | Image fixing | | characters/ | |
| | | amount | Magnetite | complex | PP wax | particle | | enabled | Anti- | image | Film |
| | | (weight | (weight | (weight | (weight | diameter | Storage | temperature | offset | adhering | image |
| Experiment No. | Kind or type | part) | part) | part) | part) | (μm) | property | (° C.) | property | property | state |
| Example 22 | Example 1 | 100 | 80 | 2 | 0 | 10.1 | ⊚ | 130 | ◯ | ◯ | ◯ |
| Example 23 | Example 2 | 100 | 80 | 2 | 0 | 9.9 | ⊚ | 135 | ◯ | ◯ | ◯ |
| Example 24 | Example 3 | 100 | 80 | 2 | 0 | 10 | ⊚ | 140 | ◯ | ◯ | ◯ |
| Comparative | Comparative | 100 | 80 | 2 | 9 | 10.2 | ⊚ | 170 | X | Δ | X |
| example 3 | example 1 | | | | | | | | | | |
| Example 25 | Example 5 | 100 | 80 | 2 | 0 | 9.5 | ⊚ | 150 | Δ | ◯ | Δ |
| Example 26 | Example 6 | 100 | 80 | 2 | 0 | 10.1 | ⊚ | 140 | ◯ | ◯ | ◯ |
| Example 27 | Example 7 | 100 | 80 | 2 | 0 | 10.5 | ⊚ | 150 | ◯ | Δ | Δ |
| Example 28 | Example 8 | 100 | 80 | 2 | 0 | 9.8 | ⊚ | 140 | ◯ | ◯ | ◯ |
| Example 29 | Example 9 | 100 | 80 | 2 | 0 | 9.6 | ⊚ | 140 | ◯ | ◯ | Δ |
| Example 30 | Example 10 | 100 | 80 | 2 | 0 | 9.9 | ◯ | 130 | ◯ | ◯ | ◯ |
| Example 31 | Example 11 | 100 | 80 | 2 | 0 | 9.7 | ◯ | 130 | ◯ | ◯ | ◯ |

### INDUSTRIAL APPLICABILITY

According to the binder resin for electrostatic charge image developing toner of the present invention, as the suitable low-molecular-weight resin and high-molecular-weight resin making up the toner, a styrene polymer is used and, with the aim of mainly improving the anti-offset property and fixing property, the waxes such as polypropylene wax are mixed therewith. By employing the method of the present invention, both the styrene copolymer and the waxes, in which phase separation is liable to occur when being kneaded due to poor compatibility between the styrene copolymer and the waxes, can be mixed with high uniformity and, therefore, too-fine pulverization, toner-spent, toner filming caused by friction among toner particles in a copying machine or printer and between toner and carrier are hard to occur.

When ferrite, magnetite, or the like is used as the colorant serving also as a magnetizer instead of carbon black, amounts of waxes to be used in the present invention are twice as large as the amount of waxes to be used when carbon black is used, however, even if so much waxes are used, according to the present invention, the waxes can be uniformly mixed with the binder resin and pigment.

The binder resin for electrostatic charge image developing toner produced by the present invention can be used suitably for production of toner being excellent in an anti-blocking property (non-aggregating property) at a time of storage, anti-offset property, fixing property, toner-spent preventing property, filming preventing property, developing property at a time of image formation and having less odor.

1. A process for producing a binder resin for electrostatic charge image developing toner comprising a step (1) of mixing a raw material for said binder resin which contains a low-molecular-weight resin and a high-molecular-weight resin and a step (2) of simultaneously therewith and/or thereafter removing a volatile component, wherein said raw material used in said step (1) further contains waxes.

2. The producing process according to claim 1, wherein said low-molecular-weight resin is made by bulk polymerization.

3. The producing process according to claim 1, wherein a weight-average molecular weight (Mw_{L}) of said low-molecular-weight resin is within a range between 1,000 and 50,000.

4. The producing process according to claim 1, wherein a molecular weight peak value (Mp_{L}), obtained by GPC (gel permeation chromatography), of said low-molecular-weight resin is within a range between 1,500 and 30,000 and a ratio (Mw_{L}/Mn_{L}) of said weight-average molecular weight (Mw_{L}) to a number-average molecular weight (Mn_{L}) is less than 4.

5. The producing process according to claim 1, wherein said low-molecular-weight resin is a styrene polymer.

6. The producing process according to claim 1, wherein said low-molecular-weight resin is in a fused state.

7. The producing process according to claim 1, wherein said high-molecular-weight resin is made by emulsion polymerization.

8. The producing process according to claim 1, wherein a weight-average molecular weight (Mw_{H}) of said high-molecular-weight resin is 100,000 or more.

9. The producing process according to claim 1, wherein a molecular weight peak value (Mp_{H}), obtained by GPC, of said high-molecular-weight resin is within a range between 300,000 and 3,000,000.

10. The producing process according to claim 1, wherein said high-molecular-weight resin is in a form of an aqueous dispersed liquid.

11. The producing process according to claim 1, wherein said waxes are selected from an aliphatic hydrocarbon wax, fatty acid ester wax, fatty acid wax, aliphatic alcohol wax, carboxamide wax, their derivatives and their mixture.

12. The producing process according to claim 1, wherein said waxes are an aliphatic hydrocarbon wax.

13. The producing process according to claim 1, wherein said waxes contains a low-molecular-weight polyolefin wax.

14. The producing process according to claim 1, wherein a softening point of each of said waxes is within a range between 55° C. and 160° C.

15. The producing process according to claim 1, wherein said waxes are added in a form of aqueous dispersed liquid.

16. The producing process according to claim 1, wherein each of said high-molecular-weight resin and said waxes is mixed together in advance in a form of aqueous dispersed liquid.

17. The producing process according to claim 1, wherein said waxes are in a fused state.

18. The producing process according to claim 1, wherein a mixing rate of said low-molecular-weight resin is within a range between 50 weight parts and 80 weight parts with respect to 100 weight parts of the total of said low-molecular-weight resin and said high-molecular-weight resin.

19. The producing process according to claim 1, wherein a mixing rate of each of said waxes is within a range between 0.1 weight parts and 10 weight parts with respect to 100 weight parts of the total of said low-molecular-weight resin and said high-molecular-weight resin.

20. The producing process according to claim 1, further comprising a step (3) of further mechanically kneading substantially solventless resin mixture obtained after said step (1) and said step (2).

21. The producing process according to claim 1, wherein said step (1), said step (2), and said step (3) to be performed when necessary are carried out in an inert gas atmosphere.

22. The producing process according to claim 21, wherein said inert gas is nitrogen gas.

23. The producing process according to claim 1, wherein said step (1), said step (2), and said step (3) to be performed when necessary are carried out by using at least one means having a heating function, mixing function, and/or volatile component removing function.

24. The producing process according to claim 23, wherein said means is selected from a heating kneader, bambury mixer, roll mill, uniaxial continuous kneader, biaxial continuous kneader, continuous mixing solvent removing machine, and drying machine.

25. The producing process according to claim 23, wherein said means is a uniaxial continuous kneader or biaxial continuous kneader.

26. A binder resin for electrostatic charge image developing toner produced by processes according to claim 1.

27. A process of producing electrostatic charge image developing toner comprising a process of mixing a colorant with the binder resin for electrostatic charge image developing toner produced by the processes according to claim 1.

28. An electrostatic charge image developing toner produced by the processes according to claim 27
